(19) United States
(12) Patent Application Publication
(10) Pub. No.: US 2026/0289164 A1
(43) Pub. Date: Sep. 24, 2026

(54) SYSTEM

(71) Applicant: SoftBank Group Corp., Tokyo (JP)

(72) Inventor: Kyoko YAGINUMA, Tokyo (JP)

(73) Assignee: SoftBank Group Corp., Tokyo (JP)

(21) Appl. No.: 19/562,116

(22) Filed: Mar. 10, 2026

(30) Foreign Application Priority Data
Mar. 19, 2025 (JP) 2025-044993

(51) Int. Cl. G06F 40/40; G06F 40/284; G06F 40/30; G06V 40/16; G10L 15/183; G10L 25/63

(52) U.S. Cl. CPC G06F 40/40; G06F 40/284; G06F 40/30; G06V 40/174; G10L 15/183; G10L 25/63

(57) ABSTRACT

A system includes a processor that is configured to generate a prompt sentence using a generative artificial intelligence model and ask questions regarding a motivation for application and a skill set of a user, automatically generate an additional question based on an answer of the user, analyze a content of the answer to create a summary and evaluate a degree of match with a predefined human resource profile and convert the degree of match into a score, and analyze a voice and a facial expression of an applicant by using a speech recognition technique and an image analysis technique, determine an emotional state of the applicant, and reflect the emotional state in the evaluation.

### CROSS-REFERENCE TO RELATED APPLICATION

This application is based on and claims priority under 35 USC 119 from Japanese Patent Application No. 2025-044993 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional interview support systems primarily focus on recording textual answers and performing simple keyword-based analysis, and therefore fail to provide a comprehensive and objective evaluation of an applicant. In particular, such systems do not sufficiently exploit generative artificial intelligence for dynamically generating questions tailored to each applicant, and they do not adequately summarize complex answer content in a manner that facilitates efficient review by human evaluators. Furthermore, conventional systems generally rely only on textual information and do not incorporate multimodal information such as voice and facial expressions. As a result, these systems cannot properly recognize an applicant's emotional state, such as nervousness, confidence, or inconsistency, and therefore cannot reflect such emotional states in the evaluation. Consequently, reliability of the evaluation, including a degree of match with an ideal human resource profile, remains limited, making it difficult for companies to select suitable candidates efficiently and fairly. There is thus a need for a system that can automatically generate appropriate interview prompts using a generative artificial intelligence model, dynamically generate additional questions based on the applicant's answers, summarize the answers, evaluate a degree of match with a predefined human resource profile, and further analyze the applicant's emotional state based on voice and facial expressions so as to improve the reliability and objectivity of the evaluation.

### SUMMARY

In order to solve the above-described problems, an aspect of the present invention provides a system comprising a processor, wherein the processor is configured to generate a prompt sentence using a generative artificial intelligence model and ask questions regarding a motivation for application and a skill set of a user, automatically generate an additional question based on an answer of the user, analyze a content of the answer to create a summary and evaluate a degree of match with a predefined human resource profile and convert the degree of match into a score, and analyze a voice and a facial expression of an applicant by using a speech recognition technique and an image analysis technique, determine an emotional state of the applicant, and reflect the emotional state in the evaluation. In one embodiment, the processor is configured to analyze the content of the answer and generate the additional question based on the analyzed content, so that follow-up questions can be adaptively tailored to each individual applicant. In another embodiment, the processor is configured to convert the degree of match with the predefined human resource profile into the score and evaluate a reliability of the evaluation in consideration of the emotional state, thereby enabling an evaluator to obtain an integrated and objective assessment that takes into account both textual content and emotional cues of the applicant.

The term “system” refers to an apparatus or combination of hardware and software components that are configured to execute processing related to interview support, including question generation, answer analysis, evaluation, and emotional state determination.

The term “processor” refers to one or more hardware processing units, such as a CPU, GPU, or dedicated accelerator, which execute computer-readable instructions to perform the functions specified in the claims.

The term “generative artificial intelligence model” refers to a machine learning model that is capable of generating natural language text or other content, based on an input such as a prompt, by learning patterns from training data.

The term “prompt sentence” refers to a text string generated by the generative artificial intelligence model, which serves as an instruction or question presented to a user during an interview.

The term “motivation for application” refers to information describing a reason or purpose for which a user applies for a position, including goals, interests, and expectations regarding the position or organization.

The term “skill set” refers to a collection of abilities, technical skills, knowledge areas, and soft skills possessed by a user that are relevant to a job or position.

The term “additional question” refers to a follow-up question that is generated automatically based on at least part of a user's previous answer, in order to obtain further or more detailed information.

The term “answer” refers to a response provided by a user to a question or prompt sentence, including textual input and, in some embodiments, spoken or otherwise captured content.

The term “content of the answer” refers to the substantive information contained in the user's answer, including words, phrases, topics, and semantic meaning.

The term “summary” refers to a condensed representation of the content of one or more answers, in which important or representative information is extracted and expressed in a shorter form.

The term “predefined human resource profile” refers to a previously set target profile representing an ideal or desired candidate, including required or preferred skills, experience, and personal attributes.

The term “degree of match” refers to a quantitative or qualitative measure indicating how closely a user's profile, derived from answers, corresponds to the predefined human resource profile.

The term “score” refers to a numerical value generated based on the degree of match, which represents an evaluation result in a form that can be compared among users or candidates.

The term “speech recognition technique” refers to a method or algorithm that converts spoken language contained in an audio signal into textual or symbolic data for analysis.

The term “image analysis technique” refers to a method or algorithm that analyzes image or video data to detect, extract, or classify features such as facial expressions, movements, or visual patterns.

The term “voice of an applicant” refers to an audio signal or spoken utterance produced by the applicant during the interview, including information such as tone, pitch, speed, and content.

The term “facial expression of an applicant” refers to a visual manifestation of the applicant's face, including movements or positions of facial muscles, that can indicate an emotional state.

The term “emotional state” refers to a mental or affective condition of the applicant, such as confidence, nervousness, stress, satisfaction, or uncertainty, estimated from voice and facial expressions.

The term “evaluation” refers to an assessment process in which data derived from answers, degree of match with the predefined human resource profile, and emotional state are integrated to produce a comprehensive judgment about the applicant.

The term “reliability of the evaluation” refers to a level of trustworthiness or robustness of the evaluation result, which takes into account not only the degree of match but also the emotional state and consistency of the applicant's responses.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5 G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

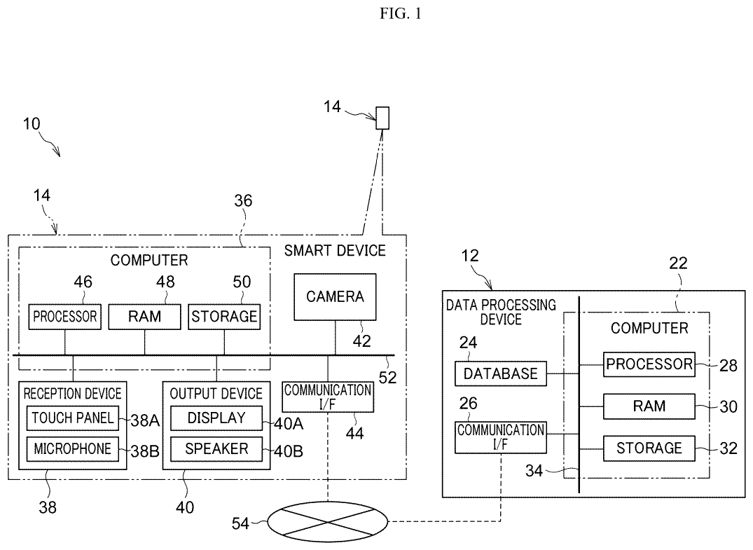

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

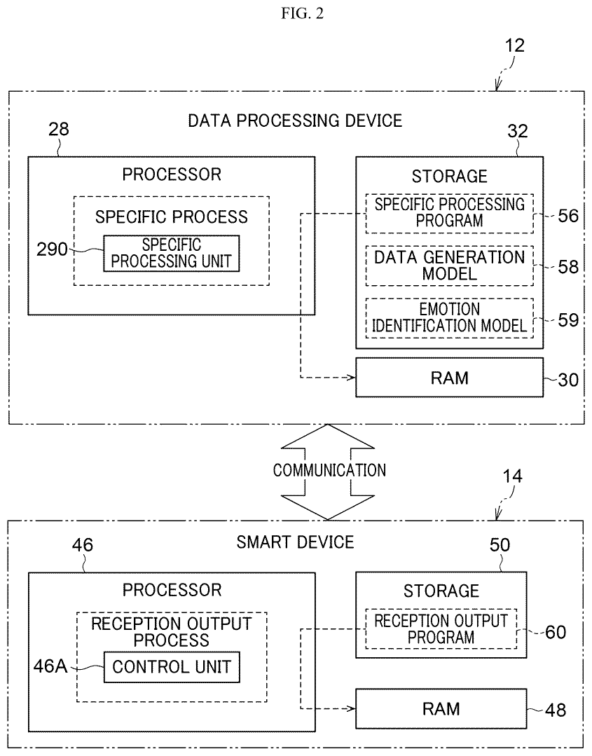

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented interviewing systems typically present static, script-based questions and record textual or audio responses without deeply analyzing the semantic content of the responses in real time. Such systems often rely on fixed branching logic, which is limited in its ability to adapt question flow to the specific motivation, experience, and capabilities expressed by each applicant. As a result, the interaction quality is low, the depth and relevance of follow-up questions are insufficient, and the collected data is not optimally structured for downstream machine evaluation.

Further, known systems that apply machine learning or natural language processing often perform analysis as an offline batch process. These systems do not dynamically generate prompt sentences for a generative AI model based on the evolving state of an ongoing interview session.

They also do not systematically manage a question/answer history in a way that feeds back into the generation of subsequent prompts and questions. This leads to inefficient use of computational resources, fragmented state management, and difficulty in obtaining consistent, explainable evaluations across different sessions.

In addition, although some systems may incorporate audio or image analysis for detecting emotions, such processing is frequently decoupled from the core logic of question generation and suitability scoring. Emotional state information, where present, is often used only as a supplementary flag, not as an integrated parameter that influences a reliability indicator or the weighting of scores. This separation reduces the effectiveness of multimodal analysis and can result in unstable or non-transparent evaluation outcomes.

From a computer technology perspective, there is a need for an improved server-centric architecture that (i) manages structured interview question sets and session states in a unified manner, (ii) constructs and updates prompt sentences for a generative AI model based on live answer content and analysis results, (iii) automatically generates individualized follow-up questions for each applicant, and (iv) integrates multimodal emotional state information into suitability scoring and a reliability index. Without such an integrated mechanism, the computing system cannot efficiently orchestrate database operations, real-time model inference, and stateful interview flow control to deliver consistent, scalable, and explainable automated interview evaluations.

The specific processing by the specific processing unit 290 of the data processing device 12 in Example 1 is realized by the following means.

The present invention provides a server comprising a processor, a storage device configured to store structured information, a communication interface, an audio processing device, and an image processing device, wherein the processor is configured to acquire, from the storage device, an interview question group based on identification information and hold the interview question group in a working memory area; to receive, via the communication interface, authentication information and interview type information from a terminal, to generate an interview session identifier, to transmit the interview session identifier to the terminal, and to manage interview state information based on the interview session identifier; to generate a prompt sentence for a generative AI model using at least a part of the interview question group as input information, to transmit the prompt sentence to the generative AI model, to acquire an initial question sentence for presentation to an applicant from the generative AI model, and to transmit the initial question sentence to the terminal; to receive, from the terminal via the communication interface, response information including the interview session identifier and an answer text of the applicant, and to store the response information in association with the interview session identifier in the storage device; to generate an analysis prompt sentence including the answer text, to transmit the analysis prompt sentence to the generative AI model, to acquire analysis result information including key point information relating to a motivation and an ability of the applicant and point-to-probe information indicating items to be further explored, and to store the analysis result information in the storage device; to generate a follow-up question generation prompt sentence using the analysis result information as input information, to transmit the follow-up question generation prompt sentence to the generative AI model, to acquire an additional question sentence for the applicant from the generative AI model, and to transmit the additional question sentence to the terminal; to determine, based on question history information and answer history information corresponding to the interview session identifier, whether to continue execution of an interview or to terminate the interview, and, when it is determined to terminate the interview, to generate an evaluation prompt sentence that summarizes the question history information, the answer history information, and the analysis result information, to transmit the evaluation prompt sentence to the generative AI model, to acquire summary information of the applicant and suitability evaluation information from the generative AI model, and to record the suitability evaluation information as score information in the storage device; and to estimate emotional state information of the applicant based on audio information obtained from the audio processing device and image information obtained from the image processing device, and to reflect the emotional state information in the suitability evaluation information, and further wherein the processor is configured to change content of the follow-up question generation prompt sentence in accordance with the point-to-probe information included in the analysis result information so as to automatically generate different additional question sentences for respective applicants, and to calculate a reliability index based on the emotional state information with respect to the suitability evaluation information and to record the reliability index in association with the score information in the storage device. This enables improvement of computer functionality by providing an integrated, stateful server-side control mechanism that dynamically constructs and updates prompt sentences for a generative AI model, generates individualized follow-up questions in real time, and combines structured interview histories with multimodal emotional state information to produce consistent, explainable suitability scores and reliability indices using coordinated database operations, model inference calls, and session management logic.

The term “processor” refers to a hardware computation unit or a set of hardware computation units, such as a central processing unit or a graphics processing unit, configured to execute instructions that implement the functions described in this specification.

The term “storage device” refers to a non-transitory computer-readable medium, such as a magnetic storage medium, an optical storage medium, a semiconductor memory, or a combination thereof, configured to store structured or unstructured data including programs, question data, response data, and analysis results.

The term “structured information” refers to data that is organized according to a predetermined schema or format, such as records in a relational database, entries in a key-value store, or objects in a document database, enabling efficient retrieval and association by identification information.

The term “communication interface” refers to a hardware and software combination that enables data exchange between the server and an external device, such as a network interface controller and associated communication stack that support protocols including transmission control protocol and hypertext transfer protocol.

The term “audio processing device” refers to a hardware component and associated software configured to acquire, pre-process, or analyze audio signals, including but not limited to microphones, analog-to-digital converters, and signal processing modules that generate audio information usable by the processor.

The term “image processing device” refers to a hardware component and associated software configured to acquire, pre-process, or analyze image or video signals, including but not limited to imaging sensors, frame grabbers, and image processing modules that generate image information usable by the processor.

The term “terminal” refers to an external information processing apparatus operated by a user, such as a mobile device, a desktop computer, or a web client, configured to exchange data with the server via the communication interface and to present an interview user interface.

The term “interview question group” refers to a collection of one or more question records stored in the storage device, each question record including at least a question text and optionally associated attributes such as category, difficulty level, and sequence information.

The term “identification information” refers to a data item, such as an identifier string or numerical code, used by the processor to specify or retrieve an interview question group, a session, or other stored information from the storage device.

The term “working memory area” refers to a temporary storage region, typically in volatile memory such as random access memory, used by the processor to hold data, including interview question groups and session state information, during execution of program instructions.

The term “authentication information” refers to data used to verify the identity of a user or terminal, including but not limited to user identifiers, passwords, access tokens, cryptographic credentials, and biometric authentication results.

The term “interview type information” refers to data indicating a category or configuration of an interview, such as a job role type, a scenario type, or an assessment profile, used by the processor to select an appropriate interview question group and control logic.

The term “interview session identifier” refers to a unique data value generated by the processor to distinguish one interview session from another, the value being used as a key to associate question history information, answer history information, and analysis result information in the storage device.

The term “interview state information” refers to data representing a current status of an interview session, including at least a current question index, previously asked questions, received answers, and control flags indicating whether the interview is ongoing or terminated.

The term “generative AI model” refers to a machine learning model, such as a large language model or sequence-to-sequence model, that is configured to generate output text or structured data in response to an input prompt sentence, based on parameters learned from training data.

The term “prompt sentence” refers to textual input data, including instructions, constraints, and contextual information, provided by the processor to the generative AI model in order to cause the generative AI model to generate a desired output such as a question, an analysis result, or a summary.

The term “initial question sentence” refers to a text string representing a first interview question to be presented to an applicant in an interview session, wherein the text string is at least partly generated or refined by the generative AI model based on a prompt sentence.

The term “response information” refers to data received from the terminal that includes at least the interview session identifier and an answer text input by the applicant in response to a presented question, and optionally includes timestamps, question identifiers, and metadata.

The term “answer text” refers to textual data representing the content of an applicant's answer to an interview question, the textual data being generated directly by user input or indirectly by speech-to-text processing.

The term “analysis prompt sentence” refers to a prompt sentence that includes at least the answer text and one or more instructions requesting the generative AI model to analyze the answer text and output analysis result information.

The term “analysis result information” refers to data generated by the generative AI model in response to the analysis prompt sentence, the data including at least key point information and point-to-probe information, and optionally including structured representations such as labels or scores.

The term “key point information” refers to data indicating extracted main elements from the answer text, such as motivations, abilities, experiences, or other salient factors relevant to assessment of the applicant.

The term “point-to-probe information” refers to data specifying aspects of the applicant's answer that remain unclear or incomplete and that should be further explored through additional questions.

The term “follow-up question generation prompt sentence” refers to a prompt sentence generated by the processor that includes at least the analysis result information and instructions requesting the generative AI model to generate one or more additional question sentences tailored to the applicant.

The term “additional question sentence” refers to a text string representing a follow-up interview question generated by the generative AI model based on the follow-up question generation prompt sentence, intended to probe deeper into specific aspects of the applicant's motivation or ability.

The term “question history information” refers to data stored in association with an interview session identifier that indicates which questions, including initial and additional questions, have been presented to the applicant and in what order.

The term “answer history information” refers to data stored in association with an interview session identifier that indicates the answers provided by the applicant to each question in the question history information.

The term “evaluation prompt sentence” refers to a prompt sentence that summarizes at least the question history information, the answer history information, and the analysis result information, and that instructs the generative AI model to output summary information and suitability evaluation information for the applicant.

The term “summary information” refers to textual or structured data generated by the generative AI model that concisely describes the applicant's overall motivation, abilities, and other relevant characteristics based on the interview data.

The term “suitability evaluation information” refers to data generated by the generative AI model indicating an evaluation of the applicant's suitability for a target role or profile, the data including at least a qualitative or quantitative assessment.

The term “score information” refers to a numerical or categorical value derived from the suitability evaluation information, stored in the storage device, and used as a machine-readable representation of an applicant's suitability level.

The term “audio information” refers to digital data derived from audio signals associated with the applicant, including but not limited to speech features, prosody features, and other acoustic parameters usable for estimating emotional state.

The term “image information” refers to digital data derived from image or video signals associated with the applicant, including but not limited to facial features, facial expressions, and body posture features usable for estimating emotional state.

The term “emotional state information” refers to data representing an estimated emotional condition of the applicant, such as confidence, stress, or engagement level, inferred from the audio information and the image information.

The term “reliability index” refers to a value calculated by the processor that indicates a degree of confidence or trustworthiness associated with the suitability evaluation information, the value being based at least in part on the emotional state information.

In one embodiment, a server implements the claimed system as a network-accessible interview platform. The server includes a processor such as a multi-core central processing unit and optionally a graphics processing unit, a storage device such as a relational database and a non-transitory memory, a communication interface such as an Ethernet or wireless network adapter, an audio processing device such as a microphone interface and signal processing circuitry, and an image processing device such as a camera interface and image signal processor.

The server executes an operating system such as a general-purpose server operating system and an application framework such as a web application framework. The server communicates with at least one terminal operated by a user via a communication network.

The server stores, in the storage device, structured information including interview question groups, user account records, interview type definitions, and analysis templates. The server implements a data model in which each interview question group is stored as multiple records in a relational table, each record including a question identifier, a base question text, a category label, a difficulty level, and a sequence index. The server further stores session records, each session record being associated with an interview session identifier and including question history information, answer history information, analysis result information, suitability evaluation information, and a reliability index.

The server incorporates a generative AI model as a large language model. In one embodiment, the generative AI model is implemented as a transformer-based neural network including an embedding layer, a plurality of self-attention layers with multi-head attention, feed-forward sublayers, layer normalization, and output projection layers. The server stores parameters of the generative AI model in the storage device or in a high-speed memory attached to the processor.

The server pre-trains the generative AI model on a large corpus of natural language text and optionally fine-tunes the generative AI model on domain-specific interview data, such as anonymized question-answer pairs and evaluation summaries.

The server applies a supervised learning procedure for the generative AI model. The server defines a loss function such as a cross-entropy loss for next-token prediction, and in some embodiments augments the loss with auxiliary terms that penalize deviation from prescribed answer formats. The server updates model weights using a gradient-based optimization algorithm such as Adam or stochastic gradient descent. The server may perform data augmentation by paraphrasing questions, injecting noise into training answers, or systematically varying interview scenarios, thereby improving robustness of the generative AI model. The server stores learned parameters as tensors in the storage device.

The server uses the generative AI model in an inference mode to generate natural language outputs based on prompt sentences. The server tokenizes each prompt sentence into subword tokens using a predetermined tokenizer, maps tokens to embeddings, and processes the embeddings through the transformer layers to produce a probability distribution over candidate output tokens at each position. The server selects output tokens by applying a decoding strategy such as greedy decoding, beam search, or top-k sampling, constrained by maximum length and, in some embodiments, controlled by temperature and penalty parameters. The server thus controls the generative AI model as a deterministic or stochastic text generator subject to specific constraints.

The server generates a prompt sentence for the generative AI model based on an interview question group and an interview type. For example, the server generates a prompt sentence in the following form:

“You are an interview assistant. From the following base question, generate a clear and polite interview question for an applicant.

Base question: Why did you apply for this position?”

The server thereby directs the generative AI model to output an initial question sentence tailored to the interview type and the base question. In contrast to fixed templates, the server uses structured attributes such as category, difficulty level, and required competency to condition the prompt sentence. This configuration enables the generative AI model to generate questions that satisfy predefined structural constraints while adapting linguistic style.

The server further generates analysis prompt sentences that include applicant answers and explicit instructions for semantic extraction. For example, the server generates a prompt sentence of the following form:

“You are an AI interviewer. Analyze the following applicant answer.

Task:

1. Extract the applicant's motivation.

2. Extract any skills, knowledge, or experience that indicate ability.

3. Identify unclear points that should be probed further.

Answer: I am interested in data analysis and I would like to contribute to your company's projects.

Output format:

motivation:

abilities:

points_to_probe:”

The server provides such a structured prompt sentence to the generative AI model, causing the generative AI model to produce analysis result information that is structured in a predictable way. The server parses the output into discrete fields corresponding to motivation, abilities, and points to probe, and stores them in separate columns or nested structures in the storage device.

This design reduces parsing errors and enforces consistency across interview sessions, thereby improving computational accuracy and facilitating downstream processing.

The server then generates follow-up question generation prompt sentences by combining the analysis result information with generation instructions. For example, the server generates a prompt sentence of the following form:

“You are generating follow-up interview questions.

Based on the following applicant answer and analysis, generate one concise follow-up question that digs deeper into the applicant's motivation and ability.

Answer: I am interested in data analysis and I would like to contribute to your company's projects.

Analysis:

motivation: interest in data analysis and contributing to projects

abilities: not clearly specified

points_to_probe: specific types of data analysis projects, concrete experience with data analysis

Output: Only the question sentence.”

The server thereby induces the generative AI model to produce an additional question sentence that is conditioned not only on the answer text but also on explicit point-to-probe information.

The server modifies the prompt sentence content by inserting different point-to-probe lists for different applicants, causing the generative AI model to follow a non-conventional rule in which follow-up questions are driven by machine-detected gaps in the previous answer, rather than by static branching conditions.

The server integrates audio processing and image processing along with the generative AI model.

The server collects audio information and image information from the audio processing device and the image processing device during answer acquisition. In one embodiment, the server applies a speech recognition module based on an acoustic model and a language model to convert audio signals into text. The server further computes prosodic features such as pitch, energy, speech rate, and pause duration by applying digital signal processing operations including short-time Fourier transformation, filtering, and statistical aggregation.

The server processes image information using an image analysis module such as a convolutional neural network trained for facial expression recognition. The server extracts facial landmarks, head pose estimates, and expression scores corresponding to emotional categories such as happiness, surprise, anger, fear, sadness, and neutrality. The server maps these features into an emotional state information vector, which includes continuous scores representing levels of stress, confidence, and engagement.

The server combines audio-derived features and image-derived features into a multimodal feature vector. The server applies a classifier such as a feed-forward neural network or a recurrent neural network to this multimodal feature vector to estimate emotional state information. The server trains this classifier with labeled data representing human-judged emotional states, using a loss function such as mean squared error or cross-entropy, and updates weights with backpropagation. The server thereby produces a numeric representation of emotional state, which is independent of human subjective judgment during runtime.

The server uses the emotional state information as an input to a reliability index computation.

The server defines rules or a learned mapping that reduces or increases a reliability index based on detected anomalies, such as sudden changes in emotional state or persistently high stress levels. For example, the server decreases the reliability index if the emotional state information indicates that the applicant was significantly stressed or distracted during key questions, and the server increases the reliability index when the emotional state information is stable and consistent with the verbal content. The server stores the reliability index together with score

The server improves computer technology by integrating the generative AI model, structured prompt sentences, and multimodal analysis into a unified system that manages stateful interview sessions. In conventional systems, an interviewing application often performs only static question display and answer recording, leaving semantic analysis and follow-up question design to human operators or post-processing. In contrast, the server uses specific data structures for question groups, analysis results, and emotional state vectors, and applies non-trivial algorithms that update prompt sentences and control interview flow based on these structures. This yields several technical advantages.

First, the server improves processing speed and efficiency by avoiding repeated human intervention in the generation of follow-up questions. The server directly consumes structured analysis result information and emotional state information to construct prompt sentences in an automated pipeline. This pipeline reduces network calls by batching necessary context into compact prompt sentences, and avoids redundant interrogation of the generative AI model.

Because the server maintains a working memory area with session state, the server can efficiently reference past questions and answers without reloading large volumes of data from the storage device.

Second, the server improves evaluation accuracy by enforcing consistent analysis prompts and output formats across many sessions. By constraining the generative AI model to output specific information fields such as motivation, abilities, and points to probe, the server reduces ambiguity and variability that would arise if open-ended textual analyses were generated. The server consequently can aggregate and compare suitability evaluation information across different applicants using homogeneous data structures.

Third, the server improves data management by systematically linking question history information, answer history information, analysis result information, score information, and the reliability index through the interview session identifier. This relational linkage allows the server to retrieve and recompute evaluations with low computational overhead and supports auditability and traceability. The server may also compress or archive older sessions while retaining summary information, thereby reducing storage consumption.

Fourth, the server implements non-conventional interview control logic that cannot be trivially replicated by manual procedures. The server applies rules that adjust follow-up question generation prompt sentences according to point-to-probe information, emotional state information, and prior suitability scores. For example, the server can instruct the generative AI model to focus on clarifying technical abilities if the analysis result information shows strong motivation but weakly specified skills, or to generate shorter, stress-reducing questions if the emotional state information indicates high anxiety. Such adaptive behavior, driven by machine-generated analysis and emotion classification, represents a distinct technical mechanism beyond simple human decision-making and routine automation.

The server can be implemented in multiple variations. In one implementation, the generative AI model resides on the same physical machine as the server, with the processor invoking the model through a local library interface. In another implementation, the generative AI model executes on a separate machine or a cloud-based computing resource, and the server communicates with the model via an application programming interface. In some embodiments, the server caches frequently used prompt sentence templates and partially precomputed token embeddings to reduce latency, thereby providing faster response times to the terminal.

The terminal may be realized as a mobile device, a personal computer, or a dedicated kiosk. The terminal executes a client application that displays interview questions, captures textual or spoken answers, and sends response information to the server. The terminal may include a microphone and a camera and may transmit raw audio and image data or pre-processed features to the server. The user interacts with the terminal by reading questions and entering answers through an input interface. The user does not need to manage session identifiers or technical details; such management is handled entirely by the server.

In one example scenario, the server selects an interview question group associated with a particular role from the storage device and generates an initial prompt sentence:

“You are an interview assistant for a technical position. From the following base question, generate a concise and polite question suitable for a first interaction.

Base question: Please tell me about your motivation for applying.”

The server receives an initial question sentence from the generative AI model and presents it via the terminal. After the user provides an answer such as “I am interested in data analysis and I would like to contribute to your company's projects,” the server generates an analysis prompt sentence:

“You are an AI interviewer. Analyze the following applicant answer.

Task:

1. Extract the applicant's motivation.

2. Extract any skills, knowledge, or experience that indicate ability.

3. Identify unclear points that should be probed further.

Answer: I am interested in data analysis and I would like to contribute to your company's projects.

Output format:

motivation:

abilities:

points_to_probe:”

The server uses the structured output to generate a follow-up question generation prompt sentence:

“You are generating follow-up interview questions.

Based on the following applicant answer and analysis, generate one concise follow-up question that digs deeper into the applicant's motivation and ability.

Answer: I am interested in data analysis and I would like to contribute to your company's projects.

Analysis:

motivation: interest in data analysis and contributing to projects abilities: not clearly specified points_to_probe: specific types of data analysis projects, concrete experience with data analysis Output: Only the question sentence.”

The server subsequently receives an additional question sentence such as “What specific types of data analysis projects have you worked on, and which did you find most rewarding?” and presents this question to the user. The server continues this process, updating the interview state, analysis result information, and emotional state information, until the server determines that the interview should be terminated, and then generates an evaluation prompt sentence that summarizes the interview.

Because the server implements specific data structures, neural network training procedures, multimodal feature extraction, and rule-based control over prompt sentence construction, the described system goes beyond a mere automation of human interviewing tasks. The server improves computational efficiency, accuracy, and reliability of interview evaluations by leveraging a coordinated architecture that ties together database operations, generative AI model inference, and emotion-aware reliability estimation in a way that would not be feasible through conventional static questionnaires or simple rule engines.

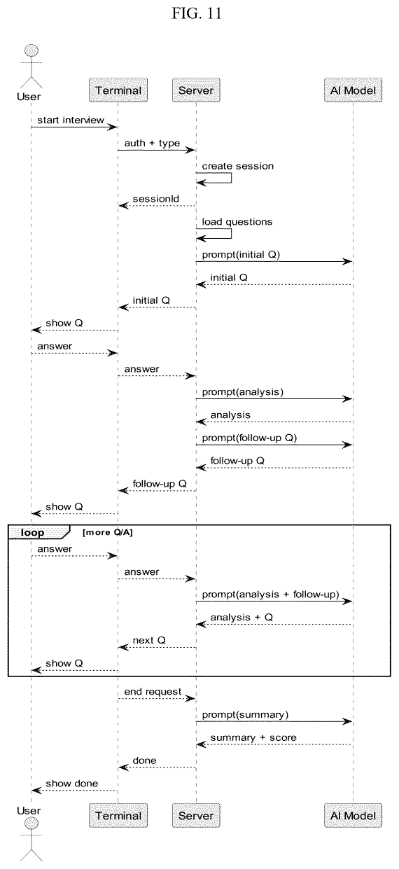

The following describes the processing flow using FIG. 11.

### Step 1

Server initializes system resources and loads interview configuration.

Server uses configuration data stored in a storage device as input, including database connection parameters, interview type definitions, and model API settings. Server establishes a connection to a relational database and executes queries to load interview question groups, each question group being identified by an interview type identifier. Server converts each database record into an internal object structure, stores these objects in a working memory area, and builds an index mapping interview type identifiers to corresponding question groups. The output of this step is an in-memory data structure containing interview question groups and a set of active configuration parameters ready for use by subsequent processing.

### Step 2

User starts an interview session from a terminal.

User operates the terminal to launch a client application or open a web page, and the terminal displays a login or identification screen. User inputs authentication information and, in some configurations, selects a desired interview type. The input of this step is user-provided information including user credentials and optional interview type selection. Terminal packages this information into a request message and sends it to the server via the communication interface. The output of this step is a formatted authentication and interview request transmitted to the server.

### Step 3

Server authenticates the user and creates an interview session.

Server receives the request from the terminal as input, extracts authentication information and interview type information, and verifies the authentication information by comparing it with user records in the database or by invoking an external authentication service. Server, upon successful authentication, generates a unique interview session identifier, initializes interview state information including current question index and status flags, and stores this state in the storage device and in working memory. Server constructs a response containing the interview session identifier and interview metadata and transmits it to the terminal. The output of this step is a valid interview session identifier associated with initialized session state.

### Step 4

Terminal stores the session identifier and prepares the interview interface.

Terminal receives the server response as input, extracts the interview session identifier and metadata, and stores the session identifier in a local memory area or secure storage. Terminal initializes its user interface to display an interview screen, sets internal flags to indicate an active session, and prepares UI elements such as question display areas and answer input fields. The output of this step is a ready-to-use interview interface on the terminal associated with the interview session identifier.

### Step 5

Server generates an initial prompt sentence for a generative AI model and obtains an initial question sentence.

Server uses the interview session identifier and interview type information as input to determine the appropriate interview question group in working memory. Server selects one or more base questions from the group, and constructs a prompt sentence for the generative AI model, for example:

“You are an interview assistant. From the following base question, generate a clear and polite interview question suitable for the first question in an interview.

Base question: Why did you apply for this position?”

Server tokenizes the prompt sentence, attaches model parameters, and sends the prompt sentence as a request to the generative AI model. Server receives as output a generated initial question sentence. Server then stores the mapping between the base question and the generated question in the storage device and prepares the question text for transmission to the terminal. The output of this step is an initial question sentence adapted by the generative AI model.

Step 6:

Server sends the initial question to the terminal.

Server takes the generated initial question sentence and the interview session identifier as input, builds a structured response message including question identifiers, question text, and any display metadata, and transmits this message to the terminal via the communication interface.

Server updates the interview state information to indicate that this question is now the current question. The output of this step is a network message containing the initial question to be displayed by the terminal.

### Step 7

Terminal displays the initial question and collects the user's answer.

Terminal receives the question message from the server as input, parses the message, and renders the initial question sentence in the user interface. User reads the question and provides an answer using text input or speech input. When speech is used, the terminal applies local speech-to-text processing or forwards audio to a speech recognition engine to obtain answer text. The input of this step for the terminal is the question text and user-generated answer content. Terminal displays the answer for confirmation and waits for the user to submit it. The output of this step is an answer text ready to be transmitted to the server.

### Step 8

Terminal sends response information including answer text to the server.

Terminal takes the interview session identifier, question identifier, and answer text as input, packages them into response information including timestamps and optional metadata, and transmits this response information to the server over the communication interface. The terminal may compress or encode the data to reduce transmission size. The output of this step is a network message containing structured response information for the current question.

### Step 9

Server records the raw answer and prepares analysis data.

Server receives the response information as input, validates the interview session identifier against current session state, and confirms that the question identifier matches the expected current question. Server writes the raw answer text, together with the interview session identifier, question identifier, and timestamp, into answer history information in the storage device. Server then constructs an analysis input object containing the answer text and any relevant context such as the base question and interview type. The output of this step is a stored answer record and an analysis input object to be used for semantic processing.

### Step 10

Server generates an analysis prompt sentence and obtains analysis result information from the generative AI model.

Server uses the analysis input object as input and constructs an analysis prompt sentence, for example:

“You are an AI interviewer. Analyze the following applicant answer.

Task:

1. Extract the applicant's motivation.

2. Extract any skills, knowledge, or experience that indicate ability.

3. Identify unclear points that should be probed further.

Answer: I am interested in data analysis and I would like to contribute to your company's projects.

Output format:

motivation:

abilities:

points_to_probe:”

Server tokenizes this analysis prompt sentence and sends it to the generative AI model. The generative AI model processes the prompt and returns an output that the server interprets as analysis result information, including at least motivation, abilities, and points_to_probe fields.

Server parses the generated text into structured data, possibly using rule-based parsing or pattern matching. Server stores the analysis result information in the storage device linked to the corresponding answer record. The output of this step is structured analysis result information associated with the answer.

### Step 11

Server generates a follow-up question generation prompt sentence based on the analysis result information.

Server takes the analysis result information and, optionally, the original answer text and question text as input, and constructs a follow-up question generation prompt sentence, for example:

“You are generating follow-up interview questions.

Based on the following applicant answer and analysis, generate one concise follow-up question that digs deeper into the applicant's motivation and ability.

Answer: I am interested in data analysis and I would like to contribute to your company's projects.

Analysis:

motivation: interest in data analysis and contributing to projects

abilities: not clearly specified

points_to_probe: specific types of data analysis projects, concrete experience with data analysis

Output: Only the question sentence.”

Server embeds the point-to-probe information into the prompt sentence so that different analysis results lead to different prompt sentences. Server tokenizes this prompt and prepares it for transmission to the generative AI model. The output of this step is a follow-up question generation prompt sentence that explicitly encodes machine-derived points to probe.

### Step 12

Server obtains an additional question sentence from the generative AI model and validates it.

Server sends the follow-up question generation prompt sentence to the generative AI model as input. The generative AI model outputs a candidate additional question sentence. Server receives this sentence and applies validation rules, such as checking for maximum length, prohibited terms, and required interrogative structure. Server may perform automatic corrections such as trimming whitespace or adjusting punctuation. Server then stores the validated additional question sentence in the storage device as part of question history information. The output of this step is a validated additional question sentence ready to be sent to the terminal.

### Step 13

Server sends the additional question sentence to the terminal.

Server uses the additional question sentence, new question identifier, and interview session identifier as input to build a response message. Server updates interview state information to set the new additional question as the current question and increments counters such as follow-up depth. Server transmits the response message to the terminal via the communication interface.

The output of this step is a network message that instructs the terminal to display the additional question.

### Step 14

Terminal displays the additional question and collects the next answer.

Terminal receives the message containing the additional question as input, parses the content, and updates the user interface to display the new question sentence. User reads the additional question and provides a more detailed answer via text or speech. Terminal processes any speech input to obtain text, and then stores the answer text temporarily in local memory. User confirms and submits the answer. The output of this step is another answer text associated with the additional question, ready for transmission to the server.

### Step 15

Server acquires audio information and image information and estimates emotional state information.

Server receives, as input, audio information and image information from the audio processing device and image processing device during or in association with answer acquisition. Server extracts audio features such as pitch, energy, and speaking rate by applying digital signal processing operations to the audio signal. Server extracts image features such as facial landmarks and expression vectors using a convolutional neural network or similar image analysis algorithm.

Server concatenates audio features and image features into a multimodal feature vector. Server inputs this vector into a trained classifier to compute emotional state information, such as stress level and engagement score. Server stores the emotional state information in the storage device in association with the corresponding answer record. The output of this step is a numeric representation of emotional state linked to the interview session.

### Step 16

Server evaluates whether to continue or terminate the interview based on history and control rules.

Server uses question history information, answer history information, analysis result information, and internal control parameters as input. Server evaluates conditions such as maximum number of questions reached, coverage of required competency categories, or convergence of suitability estimates. Server may also consider emotional state information to avoid overloading the user.

Based on these data, server applies rule-based or learned decision logic to determine whether to generate further additional questions using Steps 10 to 13, or to terminate the interview. The output of this step is a decision value indicating continuation or termination.

### Step 17

Server generates an evaluation prompt sentence for final summarization and scoring when termination is selected.

Server takes, as input, aggregated question history information, answer history information, analysis result information, and emotional state information associated with the interview session identifier. Server constructs an evaluation prompt sentence, for example:

“You are an AI recruiter.

Based on the following interview history and analyses,

1. Summarize the applicant's motivation and ability.

2. Highlight strengths and weaknesses.

3. Provide an overall suitability score from 1 to 5.

Interview data:

[structured description of questions, answers, and analyses]

Output format:

summary:

strengths:

weaknesses:

score:”

Server formats the interview data into a compact textual description inserted into the prompt sentence. The output of this step is a detailed evaluation prompt sentence provided to the generative AI model.

### Step 18

Server obtains summary information and suitability evaluation information and computes a reliability index.

Server sends the evaluation prompt sentence to the generative AI model as input and receives generated output that the server interprets as summary information and suitability evaluation information, including a score. Server parses the generated text according to the requested output format and stores the parsed data as structured fields in the storage device. Server then takes emotional state information across the session as input and computes a reliability index by applying predefined rules or a learned mapping, such as decreasing the index if emotional volatility is high during key questions. Server associates the reliability index with the score information and writes both to the storage device as part of the final interview result. The output of this step is a complete evaluation record including summary, score, and reliability index.

### Step 19

Terminal receives completion information and informs the user of interview completion.

Terminal receives, as input, a completion message from the server indicating that the interview session is terminated and optionally including high-level feedback. Terminal updates its user interface to display a completion screen, informing the user that the interview has ended and no further input is required. Terminal may offer options such as closing the application or returning to a main menu. The output of this step is a completed interaction on the terminal side with a clear indication of interview completion to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented interview systems typically present fixed question sets and record applicant answers in a largely linear manner. In such systems, processing performed by general-purpose hardware is limited to simple storage and display operations, and any analysis of answers is either manual or based on superficial keyword matching. As a result, the computing environment does not fully exploit advanced machine learning resources, and the underlying computer technology remains a basic question-answer recorder rather than an adaptive, context-aware information processing platform.

In particular, known systems exhibit several technical limitations. First, server-side processing does not dynamically construct input instructions for a generative AI model based on structured linguistic features of applicant answers and accumulated interview context. Instead, models are typically called with static or coarse-grained prompts, leading to inefficient use of computational resources and failure to generate targeted follow-up questions. This results in unnecessary network calls, redundant model inference, and increased processing latency without corresponding informational gain.

Second, conventional architectures do not tightly integrate automatic speech recognition, natural language processing, and generative AI into a coordinated pipeline managed by the processor.

Audio capture on the terminal is often decoupled from semantic analysis on the server, and the server does not convert recognized text into structured data that can be reused across multiple inferences. Consequently, each model invocation reprocesses raw or semi-processed text, consuming additional processor cycles and memory bandwidth and increasing the end-to-end response time for interactive questioning.

Third, while some systems attempt to estimate applicant affect, they commonly process audio and image data in isolation and apply emotion detection only as an auxiliary display element.

Technical mechanisms to incorporate emotion-related signals into the formal scoring logic and to adjust reliability of computed scores based on temporal patterns of emotional state are insufficient. The processor therefore fails to exploit cross-modal data and time-series behavior to refine evaluation outputs, resulting in underutilization of sensor data and imprecise decision-support metrics.

Fourth, the output layer in conventional systems merely stores or displays scores without providing an integrated management interface that exposes both numerical evaluation information and reliability information generated from emotion analysis. Interviewers are forced to manually reconcile disparate data points, which diminishes the practical utility of the server's computations and undermines the performance benefits of the automated processing pipeline.

Accordingly, there is a need for a computer-implemented system and server-side processing architecture that improve the way a processor coordinates speech recognition, natural language processing, and generative AI inference, that automatically constructs and refines prompt sentences for a generative AI model based on structured data and context, that integrates multi-modal emotion analysis into scoring and reliability computation, and that outputs refined evaluation information to a management interface with reduced latency and improved computational efficiency. This improves computer technology by transforming the server from a passive storage and presentation node into an active inference controller that adapts its processing path and model invocations to content, context, and emotion signals in a technically structured manner.

The specific processing by the specific processing unit 290 of the data processing device 12 in Application Example 1 is realized by the following means.

The present invention provides a server comprising a processor configured to receive audio information of an applicant from a terminal device, convert the audio information into text-form answer information by speech recognition, apply natural language processing to the answer information to generate structured data representing motivation, experience, and capability, automatically construct a prompt sentence for a generative AI model based on the structured data and interview context information, obtain from the generative AI model a follow-up interview question sentence in response to the prompt sentence, and output the follow-up interview question sentence to the terminal device in an interactive manner; to aggregate multiple questions and answers, generate summary information from the aggregated data, calculate numerical evaluation information by computing a degree of conformity to a stored target personnel profile based on the summary information and the structured data, execute audio analysis processing and image analysis processing on audio information and image information of the applicant to estimate emotional state information, adjust the numerical evaluation information in accordance with temporal change and consistency of the emotional state information to generate reliability evaluation information, and output both the numerical evaluation information and the reliability evaluation information to a management display device. This enables the processor to implement an integrated, context-aware processing pipeline that converts unstructured multi-modal input into structured representations, dynamically optimizes prompt sentences for the generative AI model, reduces redundant computation and latency in interactive questioning, and produces refined, reliability-adjusted evaluation outputs that improve the technical functioning of the interview support system and enhance the efficiency and quality of computer-based decision support.

The term “system” refers to an arrangement of one or more computing devices, including at least one processor and associated memory and interfaces, configured to execute programmed instructions to perform interview-related processing as described herein.

The term “processor” refers to a hardware processing unit, such as a central processing unit or other programmable computation circuit, capable of executing machine-readable instructions to perform logical operations, data transformations, and control flows specified in software.

The term “terminal device” refers to a user-operated computing apparatus, such as a mobile device, tablet, or personal computer, that includes at least an input interface, an output interface, and a communication interface for interacting with the server.

The term “management display device” refers to a computing apparatus operated by an interviewer or administrator, such as a workstation or display terminal, configured to present evaluation information, scores, and related interview data.

The term “audio information” refers to electrical or digital data representing sound signals, including speech generated by an applicant and captured by an input device such as a microphone.

The term “image information” refers to electrical or digital data representing still or moving visual images, including facial expressions and body posture of an applicant captured by an imaging device such as a camera.

The term “speech recognition processing” refers to a computational procedure for converting audio information representing speech into text-form character information by applying acoustic modeling, language modeling, or other signal-processing techniques.

The term “text-form answer information” refers to character-based data representing the semantic content of an applicant's spoken response after conversion by speech recognition processing.

The term “natural language processing” refers to a class of computational techniques that analyze human language text to extract linguistic features, including syntactic structure, semantic roles, entities, and key phrases.

The term “structured data” refers to machine-readable data organized in a defined schema, such as fields or key-value pairs, representing extracted elements of an applicant's motivation, experience, and capability.

The term “motivation information” refers to data elements indicating reasons or intentions expressed by an applicant for applying to a position, as derived from answer information or structured data.

The term “experience information” refers to data elements indicating prior activities, roles, or work history of an applicant, including descriptions of tasks and responsibilities.

The term “capability information” refers to data elements indicating skills, competencies, or proficiencies of an applicant relevant to job performance.

The term “interview context information” refers to information representing the state and history of an interview session, including previously asked questions, corresponding answers, and session metadata.

The term “generative AI model” refers to a machine learning model, implemented as software executed on computing hardware, configured to generate natural language text in response to an input prompt sentence.

The term “prompt sentence” refers to a text-form instruction or query, optionally including context and constraints, that is input to a generative AI model to cause the model to generate a follow-up question, summary, or other natural language output.

The term “follow-up interview question sentence” refers to a natural language text string representing a question that is generated by a generative AI model based on prior questions, answers, and structured data, and that is output as a subsequent question to an applicant.

The term “additional question sentence” refers to a follow-up interview question sentence generated for the purpose of clarifying or supplementing missing or ambiguous information in previous answers.

The term “summary information” refers to condensed text or structured data that describes, in a reduced form, the content of multiple questions and answers from an interview session.

The term “target personnel profile” refers to stored reference data describing desired characteristics, skills, and behavioral traits for a particular role or position, used as a basis for evaluating applicant suitability.

The term “degree of conformity” refers to a quantified relationship indicating how closely an applicant's structured data and summary information match the target personnel profile.

The term “numerical evaluation information” refers to score data expressed as one or more numeric values that represent the assessed suitability or performance of an applicant.

The term “audio analysis processing” refers to computational analysis applied to audio information, including extraction of prosodic features, intensity, pitch, or other sound characteristics, to infer states such as emotion or stress.

The term “image analysis processing” refers to computational analysis applied to image information, including detection and tracking of facial features, expressions, or movements, to infer states such as emotion or engagement.

The term “emotional state information” refers to data representing an estimated affective state of an applicant, such as calmness, tension, or positivity, derived from audio analysis processing, image analysis processing, or a combination thereof.

The term “temporal change” refers to variation of emotional state information or other evaluation-related data as a function of time or across different stages of an interview session.

The term “consistency” refers to a measure of stability or coherence of emotional state information or other behavioral indicators across multiple time segments or interview questions.

The term “reliability evaluation information” refers to data indicating confidence or trustworthiness of numerical evaluation information, computed by taking into account emotional state information, temporal change, and consistency.

The term “corrected evaluation result” refers to numerical evaluation information that has been adjusted based on reliability evaluation information or emotional state information to more accurately reflect the applicant's suitability.

The term “sequentially output” refers to the operation of transmitting or presenting generated question sentences to a terminal device in an ordered manner according to progression of the interview.

In one embodiment, a server, one or more terminal devices, and one or more management display devices cooperate to implement the claimed system. The server includes at least one hardware processor, a main memory, a non-volatile storage device, and a network interface. The terminal includes at least one processor, a microphone, a camera, a display, and a wireless or wired communication interface. The management display device includes at least one processor, a display, and a communication interface capable of accessing the server over a data network.

The server executes a server application on an operating system such as a general-purpose server OS. The server application is implemented, for example, using a web application framework executing on the processor. The server application is configured to manage interview sessions, store applicant data in a database management system such as a relational database, and coordinate interaction with external processing services. The server stores program modules for speech recognition interfacing, natural language processing, generative AI model interfacing, audio analysis, image analysis, scoring, and reliability computation.

The terminal executes an interview application on an operating system such as a mobile operating system. The interview application controls the microphone and camera, presents questions on the display, and transmits captured audio and image data to the server via the communication interface. The interview application may also invoke a remote speech recognition service and send resulting text-form answer information to the server.

The user operates the terminal to answer interview questions. The user speaks into the microphone, and the interview application acquires audio information in the form of sampled digital signals, for example, pulse code modulation at a predetermined sampling rate and bit depth. The interview application may locally buffer the audio data and transmit the data to a network-accessible speech recognition service. A general-purpose speech recognition engine converts the audio waveform into text-form answer information by applying acoustic feature extraction, phoneme modeling, and language modeling. The terminal receives the recognized text and forwards the text-form answer information, along with metadata such as timestamps and question identifiers, to the server.

The server applies natural language processing to the answer information. In one embodiment, the server executes a natural language processing library such as a statistical or neural linguistic analyzer on the processor. The server loads a language model and parses the answer text into tokens, assigns part-of-speech tags, detects syntactic dependencies, and identifies named entities and key phrases. The server converts these linguistic features into structured data, for example, by constructing a record that includes fields for motivation information, experience information, capability information, and additional contextual attributes such as polarity, tense, or modality.

The server stores these structured records in the database using a defined schema. Because the server stores structured data rather than only raw text, subsequent processing modules can perform targeted operations on specific fields without reparsing the original text, thereby improving computational efficiency and reducing redundant processing.

The server constructs prompt sentences for a generative AI model based on the structured data and interview context information. The server maintains interview context information as a data structure including at least: a list of previously asked questions, corresponding answer identifiers, timestamps, and computed feature vectors derived from the structured data for each answer. The server determines whether additional information is needed by applying rule-based logic to the structured data, such as detecting missing values in required fields or detecting low confidence values associated with particular features. For example, when the structured data lacks concrete experience information, the server determines that a follow-up question focused on specific experience is necessary.

The server then constructs a prompt sentence in natural language by combining a template with values extracted from the structured data and interview context information. For instance, the server generates a prompt sentence of the following form:

“Interview context: Question: ‘Please tell us your motivation for applying for this position.’ Answer: ‘I like customer service and I agree with your company's philosophy.’ Task: As an AI interviewer, generate exactly one specific follow-up question that asks about concrete customer service experience.”

The server sends this prompt sentence to a generative AI model executing on a computing platform accessible via a network. In one embodiment, the generative AI model is a transformer-based neural network with multiple self-attention layers, trained on large-scale text corpora to predict subsequent tokens given a sequence of input tokens. The generative AI model receives the prompt sentence as a sequence of token embeddings, processes the sequence through a stack of attention and feedforward layers, and generates output token probabilities. By sampling or selecting from these probabilities under constraints such as a maximum token length or a temperature parameter, the generative AI model generates a follow-up interview question sentence. The server receives the generated text from the model and performs post-processing, such as trimming leading and trailing quotation marks, enforcing a single-sentence constraint, and filtering inappropriate terms.

The server outputs the follow-up interview question sentence to the terminal. The interview application displays the follow-up question on the terminal display. The user reads the question and provides a new spoken answer. The terminal captures new audio information, optionally captures image information of the user's face, and transmits these data to the server. The server repeats the natural language processing and structured data generation described above. Because the server uses structured data and interview context information to drive prompt construction, the generative AI model is supplied with precise, context-rich instructions, resulting in follow-up questions that are more relevant to missing or ambiguous points. Technically, this reduces the average number of model invocations needed to obtain sufficient information and reduces network traffic and latency, which constitutes an improvement in the operation of the distributed computing system.

The server further generates summary information after a set of interview questions has been completed. The server retrieves all structured data and raw answers for an interview session from the database and aggregates them into an intermediate representation. The server may compute feature vectors representing motivation patterns, experience categories, and capability clusters, for example by mapping extracted key phrases into a predefined vocabulary space. The server constructs a summary prompt sentence for the generative AI model, such as:

“You are an assistant that summarizes job interview answers for a hiring manager. Below are the questions and the candidate's answers. Summarize the candidate's motivation, skills, customer service experience, and overall suitability for a front-line retail position in about 150 words.

Questions and answers: 1) Q: . . . . A: . . . 2) Q: . . . . A: . . . 3) Q: . . . . A: . . . ”

The server sends this prompt sentence to the generative AI model, which generates a condensed summary text describing the applicant's characteristics. The server stores the summary information in the database. The use of intermediate structured data and feature vectors allows the server to limit the size and complexity of the prompt sentence while still providing the model with the most informative elements, thereby reducing the computational load on the model and improving response time.

In parallel, the server performs audio analysis processing and image analysis processing on the captured audio information and image information. In one embodiment, the server applies feature extraction to the audio signal to compute prosodic features such as pitch, intensity, speaking rate, and spectral features. The server feeds these features into a trained classifier, which may be implemented as a neural network or a support vector machine, to estimate probabilities of different emotional states. For image analysis, the server applies a convolutional neural network to frames or sequences of frames in the image information to detect facial landmarks and estimate facial expressions. The server fuses the results of audio-based and image-based emotion estimation, for example using a weighted averaging or a small fusion network, to produce emotional state information associated with each answer or time segment.

The server analyzes temporal change and consistency of the emotional state information over the course of the interview. The server represents emotional state information as a time series and computes metrics such as variance or abrupt changes in estimated emotion classes. When the emotional state remains steady and consistent with the content of the answers, the server computes higher reliability values; when the emotional state fluctuates excessively or appears inconsistent with the content, the server computes lower reliability values. These calculations are performed by deterministic algorithms executed on the processor, and the resulting reliability evaluation information is stored and associated with the numerical evaluation information.

The server calculates numerical evaluation information by comparing the structured data with a target personnel profile. The server stores one or more target personnel profiles as records in the database, each including required or preferred capabilities, types of experience, and characteristic motivation patterns, together with weighting parameters. The server computes a degree of conformity by comparing the applicant's structured data to the profile using similarity measures such as weighted matching of capability categories, counting of relevant experience segments, and matching of motivation keywords. The server then converts the degree of conformity into a numerical evaluation score. The server adjusts this score based on the reliability evaluation information derived from emotional state information. For example, the server may reduce the score for low reliability or increase the confidence interval associated with the score. This process yields corrected evaluation results that incorporate both content-based and emotion-based signals.

The server outputs the numerical evaluation information and the reliability evaluation information to the management display device. The management display device runs a browser or a dedicated management application that receives the evaluation data via the network interface and renders a user interface. The interface shows scores, reliability indicators, summaries, and key questions and answers. Because the server has already performed complex multi-modal analysis and structured data processing, the management display device can display precomputed metrics without intensive local computation, reducing client-side resource consumption.

From a technical standpoint, the configuration described above improves computer technology in several ways. First, the server introduces a non-conventional processing pipeline that converts unstructured multi-modal input into structured data, then uses that structured data to dynamically construct prompt sentences for a generative AI model. This architecture reduces duplicate parsing and redundant model calls, thereby improving processing speed and reducing network and processing load. Second, the integration of audio analysis and image analysis with structured-language-based scoring, and the explicit use of temporal consistency metrics, yields reliability evaluation information that could not be practically computed by human interviewers in real time. The server uses algorithmic rules and learned models to combine these signals, thereby reducing evaluation error and variance.

Third, the server controls the generative AI model by supplying prompt sentences that encode explicit constraints, such as “generate exactly one specific follow-up question” and “ask about concrete customer service experience.” This structured prompt design, based on prior computed features, reduces spurious or off-topic generation, increases the relevance of generated questions, and reduces the need for post-hoc filtering. As a consequence, the total number of inference cycles and the amount of data transmitted between the server and the generative AI model platform are reduced, which improves overall system throughput.

Fourth, the system applies machine learning in a manner that is not limited to simple automation of human tasks. The server not only replicates the act of asking questions but also optimizes internal data structures, inference scheduling, and model invocation strategies based on features extracted from prior input. The system uses learned models as components in a broader algorithmic framework that incorporates deterministic rules, structured data schemas, and temporal analysis. This combination yields effects such as reduced latency, improved score stability, and more efficient resource utilization across distributed computing nodes.

In alternative embodiments, the server may execute the generative AI model locally, for example on one or more graphics processing units, instead of calling an external service. In such embodiments, the server stores the parameters of a transformer-based neural network and performs forward passes on local hardware. Similarly, the terminal may perform the speech recognition processing locally using an on-device acoustic model and language model and may transmit only the recognized text to the server, reducing network bandwidth usage and improving privacy. In other variations, the server may use different natural language processing libraries or custom parsers, or may employ different emotion recognition architectures, provided that structured data and emotional state information are generated and used as described.

The described embodiments illustrate how the server, terminal, and user interact with specific hardware and software components to implement the claimed system. The server transforms raw audio, image, and text inputs into structured, evaluation-ready data by executing a defined sequence of feature extraction, natural language analysis, prompt sentence construction, generative AI inference, and multi-modal reliability computation. These implementations allow a person skilled in the art to realize the claimed system and to recognize that the combination of these operations provides concrete improvements to the functioning of the computer-based interview support system.

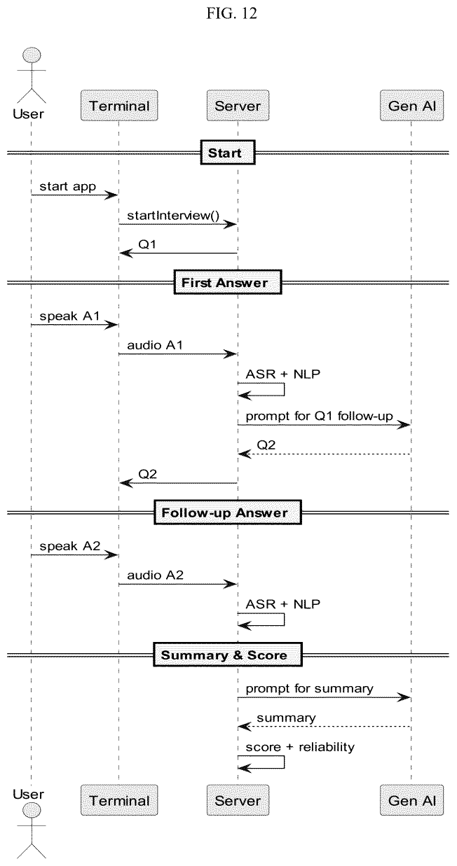

The following describes the processing flow using FIG. 12.

### Step 1

The user starts an interview session on the terminal.

The user taps an icon of an interview application on the terminal to launch the application.

The terminal loads configuration data (such as shop identifier, language setting, and server endpoint URL) from local storage and initializes a new interview session.

Input: User touch input on the terminal.

Output: An initialized interview session object stored in the terminal memory and a request message prepared for the server.

### Step 2

The terminal requests an initial question from the server.

The terminal constructs an HTTP or HTTPS request including session identifier, applicant identifier, and device information, and transmits this request to the server via a network interface.

The server receives the request, validates the session information, and queries an interview scenario table in a database to select a first interview question.

Input: Session metadata from the terminal.

Output: A question record selected by the server and transmitted to the terminal as a text string with a question identifier.

### Step 3

The terminal displays the initial question and prompts the user to answer.

The terminal renders the text of the question on the display and activates a user interface element such as a “Start Recording” button.

The user reads the question and prepares to answer by voice.

Input: Question text and question identifier from the server.

Output: A displayed question on the terminal screen and a ready state for recording.

### Step 4

The user provides a spoken answer and the terminal records audio.

The user presses a recording control and speaks into a microphone of the terminal.

The terminal activates an audio capture API, samples the audio signal at a defined sampling rate and bit depth, and stores the sampled data in a buffer.

The terminal stops recording when the user presses a stop control or when a silence detection algorithm triggers.

Input: Acoustic speech signal from the user.

Output: Digitized audio information in a predetermined format stored in the terminal memory.

### Step 5

The terminal converts the recorded audio into text-form answer information.

The terminal sends the audio information to a speech recognition engine via a network interface or invokes an on-device speech recognizer.

The speech recognition engine applies feature extraction, acoustic modeling, and language modeling to the audio signal to produce a recognized text string.

The terminal receives the recognized text and associates it with the current question identifier.

Input: Audio information captured from the user.

Output: Text-form answer information and recognition confidence values stored in the terminal and ready for transmission to the server.

### Step 6

The terminal transmits the text-form answer information to the server.

The terminal builds a message including the session identifier, question identifier, recognized text, and confidence score, and sends this message to the server over a communication channel.

The server receives the message, verifies integrity and authentication, and stores the raw answer text into a database as part of the interview session record.

Input: Text-form answer information and related metadata from the terminal.

Output: A stored answer record in the server database and an internal event indicating that analysis is required.

### Step 7

The server performs natural language processing on the answer information.

The server passes the answer text to a natural language processing module, which tokenizes the text, assigns part-of-speech tags, identifies syntactic dependencies, and detects named entities and key phrases.

The server applies rule-based matching and feature extraction to map segments of the text to motivation information, experience information, and capability information, and stores the results as structured data.

Input: Text-form answer information from the database.

Output: Structured data representing linguistic and semantic features of the answer, written into structured fields in the database.

### Step 8

The server evaluates completeness of the structured data and determines the need for a follow-up question.

The server inspects the structured data and checks for missing fields, low-confidence features, and ambiguous entities using predetermined rules or thresholds.

The server flags information gaps such as a lack of specific experience details or insufficient mention of required capabilities.

Input: Structured data generated from the answer information.

Output: A determination result indicating which aspects are incomplete and a list of target topics for follow-up questioning.

### Step 9

The server constructs a prompt sentence for a generative AI model.

The server assembles interview context information including the original question, the answer text, and the flagged gaps, and embeds this information into a prompt template.

The server generates a prompt sentence such as:

“Interview context: Question: ‘Please tell us your motivation for applying for this position.’

Answer: ‘I like customer service and I agree with your company's philosophy.’ Task: As an AI interviewer, generate exactly one specific follow-up question that asks about concrete customer service experience.”

The server encodes this prompt sentence as a text sequence ready to be sent to a generative AI model.

Input: Interview context information and determination result from the previous step.

Output: A prompt sentence describing the context and specifying constraints for generation.

### Step 10

The server sends the prompt sentence to the generative AI model and obtains a follow-up interview question sentence.

The server transmits the prompt sentence to a generative AI model endpoint through a network interface and sets inference parameters such as maximum output length and randomness control.

The generative AI model computes token probabilities in a transformer-based neural network and outputs a sequence of tokens representing a follow-up question.

The server receives the generated text and parses it as a follow-up interview question sentence.

Input: Prompt sentence generated by the server.

Output: A follow-up interview question sentence generated by the generative AI model and stored in the server memory.

### Step 11

The server validates and stores the generated follow-up interview question sentence.

The server checks the generated sentence for length, language, and content against predefined filters, and rejects or modifies the sentence if it does not meet constraints.

The server registers the validated question as a new question record linked to the current interview session in the database.

Input: Follow-up interview question sentence from the generative AI model.

Output: A stored follow-up question record associated with the session and ready to be sent to the terminal.

### Step 12

The server transmits the follow-up interview question sentence to the terminal.

The server creates a response message containing the follow-up question text and a new question identifier and sends the message to the terminal over a network connection.

The terminal receives the message and updates its local data structures to incorporate the new question into the current interview flow.

Input: Stored follow-up question record within the server.

Output: A follow-up interview question displayed on the terminal as part of the interactive session.

### Step 13

The terminal displays the follow-up question and prompts the user for another answer.

The terminal renders the follow-up question text on the display and activates a recording control in the user interface.

The user reads the new question and responds verbally by using the microphone on the terminal.

Input: Follow-up question text received from the server.

Output: A displayed follow-up question and an initiated state for capturing another spoken answer.

### Step 14

The terminal and server repeat answer acquisition and analysis for additional questions.

The terminal captures new audio information, converts the new answer to text-form answer information, and transmits it to the server.

The server performs natural language processing again, updates structured data, constructs a new prompt sentence if further clarification is required, and obtains another follow-up question from the generative AI model as needed.

Input: New spoken answers provided by the user during subsequent questions.

Output: Updated structured data records, additional follow-up questions where necessary, and a growing interview transcript stored on the server.

### Step 15

The server generates summary information for the interview session.

The server retrieves all structured data and raw text answers associated with the session and aggregates them into an internal representation, including lists of motivations, experiences, and capabilities.

The server constructs a summary prompt sentence such as:

“You are an assistant that summarizes job interview answers for a hiring manager. Below are the questions and the candidate's answers. Summarize the candidate's motivation, skills, customer service experience, and overall suitability for a front-line retail position in about 150 words.

Questions and answers: 1) Q: . . . . A: . . . 2) Q: . . . . A: . . . 3) Q: . . . . A:”

The server sends the summary prompt sentence to the generative AI model and receives a summary text, which it stores as summary information.

Input: Aggregated structured data and question-answer pairs from the database.

Output: Summary information describing the applicant's profile and stored in the database.

### Step 16

The server performs audio analysis processing and image analysis processing to estimate emotional state information.

The server collects audio segments and image frames captured during the interview, extracts acoustic features such as pitch and energy, and extracts visual features such as facial landmarks and expressions.

The server feeds these features into emotion estimation algorithms and generates emotional state information for different time segments of the interview.

Input: Audio information and image information captured during the interview session.

Output: Emotional state information represented as time-stamped labels or probability distributions stored in association with the answers.

### Step 17

The server calculates numerical evaluation information and reliability evaluation information.

The server compares the structured data against a target personnel profile, computing a degree of conformity for motivations, experiences, and capabilities using weighted similarity measures.

The server converts the degree of conformity into a numerical evaluation score and analyzes temporal change and consistency in the emotional state information to derive reliability values.

The server adjusts the numerical evaluation score based on the reliability values to produce reliability evaluation information and corrected evaluation results.

Input: Structured data for the applicant, target personnel profile, and emotional state information.

Output: Numerical evaluation information, reliability evaluation information, and corrected evaluation results written to the database.

### Step 18

The server provides evaluation results to the management display device.

The server receives a request from the management display device, retrieves the numerical evaluation information, reliability evaluation information, summary information, and selected questions and answers from the database, and formats these data as response messages.

The management display device receives the data, renders a graphical interface showing scores, reliability indicators, and textual summaries, and allows a user to inspect detailed information.

Input: Request for interview results from the management display device.

Output: Displayed evaluation results on the management display device for review by a user.

It is also possible to incorporate an emotion engine for estimating the user's emotions.

That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional interview-support systems primarily focus on digitizing and storing interview notes or on presenting static questionnaires to interviewers. In such systems, a computing apparatus typically records free-form text responses from applicants and may provide simple keyword search or template-based scoring. However, these approaches do not fully exploit advanced natural language processing capabilities and therefore suffer from several technical limitations that degrade the efficiency and reliability of computer-implemented evaluation processing.

First, conventional systems often require a human evaluator to manually read and interpret long-form response text, which results in large and irregular data units being stored and processed by the computer. Because the stored response data is not normalized or summarized by the system itself, subsequent retrieval, comparison, and scoring operations cause inefficient memory access patterns, increased processor load, and latency when handling large volumes of candidate data.

The absence of machine-generated, structured summaries prevents the system from efficiently performing downstream computational tasks such as automated ranking or cross-candidate comparison.

Second, existing systems generally do not integrate a generative AI model in a way that structurally transforms the stored response data into machine-usable evaluation features. For instance, prompt sentences, if used at all, are typically handcrafted and not systematically generated or managed by the system. As a result, the interface between stored interview responses and the generative AI model is ad hoc and not optimized for repeatable machine processing. This leads to inconsistent generation behavior, increased overhead in preparing AI calls, and difficulty in reproducing or auditing AI-based evaluations.

Third, most conventional systems do not maintain a persistent, machine-tractable evaluation history that links original responses, AI-generated summaries, quantitative indices, and follow-up question data. Without such a structured evaluation history, the computing apparatus cannot efficiently reuse past evaluation results for later comparison, model tuning, or batched analysis.

This makes it technically difficult to scale the evaluation process to a large number of candidates while maintaining low latency and predictable resource consumption.

Fourth, conventional architectures often process each AI interaction in isolation, without a defined scheme for generating and managing prompt sentences that encapsulate both raw response content and prior analytical results. The absence of such a scheme prevents the computer from systematically deepening an evaluation, for example, by programmatically generating additional interview questions tailored to previously stored responses. As a consequence, the system fails to leverage iterative AI-processing pipelines that could improve the precision and consistency of evaluation while avoiding redundant human input.

Accordingly, there is a need for a computer-implemented system that: (i) acquires and stores response information from terminals in a form suitable for downstream machine processing; (ii) automatically generates prompt sentences embedding stored response information and analysis results; (iii) interfaces in a structured manner with a generative AI model to obtain summaries and additional questions; (iv) computes quantitative indices based on comparison with evaluation criteria; and (v) persistently manages these indices and related AI outputs as evaluation history.

By addressing these issues, the present invention aims to improve the way computing resources are used to perform interview evaluation, leading to more efficient data processing, reduced manual workload, and more consistent machine-based assessments.

The specific processing by the specific processing unit 290 of the data processing device 12 in Example 2 is realized by the following means.

The present invention provides a server comprising a processor, a storage device coupled to the processor, and an input/output device coupled to the processor and configured to communicate with at least one terminal, wherein the processor is configured to acquire, via the input/output device, response information of an evaluation target person as text information from the terminal and store the text information in an information management area of the storage device, to generate a prompt sentence including the response information stored in the storage device so as to create the prompt sentence that instructs a generative AI model to generate summary information of the response information or additional question information based on the response information, to transmit the prompt sentence to an internal or external generative AI model and obtain, from the generative AI model, a generation result including the summary information or the additional question information, to store the summary information included in the generation result in an evaluation information management area of the storage device and calculate a quantitative index indicating suitability of the evaluation target person by comparing the summary information with evaluation criterion information stored in the storage device, to output the quantitative index and the additional question information included in the generation result to the terminal via the input/output device so that an evaluator can mutually compare the summary information and the quantitative index of a plurality of evaluation target persons, and to store the quantitative index in association with the response information and the summary information in the storage device and manage the quantitative index as evaluation history information usable for subsequent evaluation processing or model update processing. This enables the computer system to transform unstructured response text into structured evaluation data through coordinated use of prompt sentences and a generative AI model, thereby improving the efficiency, scalability, and consistency of machine-executed interview evaluation while reducing the computational and operational burden associated with manual analysis.

The term “processor” refers to a hardware computation unit, such as a central processing unit or an execution core, that executes instructions to perform arithmetic operations, logical operations, data transfer operations, and control operations according to a program.

The term “storage device” refers to a hardware component, such as a semiconductor memory, magnetic storage, or optical storage, that stores data and programs in a non-transitory manner and provides the stored information to a processor.

The term “input/output device” refers to a hardware and software interface component that enables data communication between the server and external devices, including terminals, over a communication network, and that transfers input data to the processor and outputs data generated by the processor.

The term “terminal” refers to an information processing apparatus, such as a client device or user interface device, that allows a user to input response information and to receive and display output information from the server via the input/output device.

The term “evaluation target person” refers to an individual whose response information is acquired and processed by the system for the purpose of determining suitability or fitness with respect to predetermined evaluation criteria.

The term “response information” refers to content data, typically in natural language text form, representing answers, explanations, or statements provided by an evaluation target person through a terminal in response to one or more questions.

The term “text information” refers to information expressed as a sequence of characters or symbols encodable in a character encoding scheme and suitable for processing by natural language processing algorithms and storage in a storage device.

The term “information management area” refers to a logical storage region within the storage device in which response information and associated data are stored in a structured or semi-structured manner under control of the processor.

The term “evaluation information management area” refers to a logical storage region within the storage device in which evaluation-related data, including summary information, quantitative indices, and other derived evaluation features, are stored and managed under control of the processor.

The term “prompt sentence” refers to a sequence of text information generated by the processor that includes at least a portion of the response information and that is formatted as an instruction or request for processing by a generative AI model.

The term “generative AI model” refers to a machine learning model, such as a neural network based language model, configured to generate text or other data outputs from input prompt sentences by performing probabilistic or learned inference on training-based parameters.

The term “generation result” refers to output data generated by the generative AI model in response to an input prompt sentence, including at least one of summary information and additional question information.

The term “summary information” refers to condensed text information generated from response information by the generative AI model or by the processor, in which key points or salient elements of the response information are extracted and represented in a shorter form.

The term “additional question information” refers to text information representing one or more further questions generated based on response information or analysis results, the questions being configured to elicit more detailed or supplemental responses from the evaluation target person.

The term “evaluation criterion information” refers to data defining one or more standards, thresholds, attribute profiles, or target profiles used by the processor to compare against summary information in order to determine suitability or fitness of an evaluation target person.

The term “quantitative index” refers to numerical or score-based data computed by the processor that represents a degree of suitability, matching, or evaluation result of an evaluation target person with respect to the evaluation criterion information.

The term “evaluation history information” refers to data stored in association with response information, summary information, quantitative indices, and related evaluation attributes, representing past evaluation activities and results for subsequent use in evaluation processing or model update processing.

The term “analysis result” refers to data derived from processing response information, such as extracted features, classifications, or interpreted attributes, which may be incorporated into a prompt sentence or used for computing evaluation metrics.

The term “classification information” refers to information representing a categorization or grouping of an evaluation target person, such as a class label or grade, determined by the processor based on summary information and evaluation criterion information.

The term “reliability information” refers to information indicating a level of confidence, trustworthiness, or robustness associated with an evaluation result, such as a probability value or confidence score computed by the processor.

The term “model update processing” refers to processing in which parameters, rules, or configurations of a predictive model or evaluation algorithm, including the generative AI model or related scoring logic, are revised or adjusted based on evaluation history information and other data.

The term “communication network” refers to a wired or wireless data transmission infrastructure, such as a local area network or wide area network, that enables data exchange between the server and one or more terminals via the input/output device.

The server implements embodiments of the invention using a combination of hardware and software resources configured to execute the claimed processing. The server includes at least one processor, a main memory, a non-transitory storage device, and an input/output interface connected to a communication network. The server executes an operating system, such as a generic server operating system, and an application framework, such as a generic web framework, to implement an interview evaluation application. The storage device stores executable programs, configuration data, response information, evaluation criterion information, summary information, quantitative indices, and evaluation history information in logically separated data structures.

The terminal operates as a client device that may be realized by a general-purpose information processing apparatus, such as a workstation, a notebook-type device, or a handheld device. The terminal includes a display unit, an input unit, a network interface, a processor, and a memory.

The terminal executes client software, such as a web browser or a dedicated application, to render user interfaces for entering response information and for displaying summary information and evaluation results. The terminal communicates with the server via the communication network using, for example, secure transport protocols, and exchanges structured data with the server by way of the input/output device of the server.

The user operates the terminal to input response information of an evaluation target person. The user enters free-form text describing, for example, motivation and skill set of a candidate into a text input area rendered by a client application on the terminal. The terminal encodes the entered text information using a character encoding scheme, stores it temporarily in a buffer area of the terminal memory, and transmits it to the server via the communication network. The terminal may attach identifier information, such as an applicant identifier and a session identifier, so that the server can associate response information with a specific evaluation target person.

The server receives the response information as text information via the input/output device and stores it in a structured data store in the storage device. In one embodiment, the server uses a relational database management system executed by the processor to define a table having fields such as “applicant_id,” “response_text,” “created_at,” and “source_terminal_id.” The server writes the received response information into this table, so that subsequent processing can perform efficient indexed access based on the identifiers. The server thereby converts unstructured input flows from terminals into normalized records, which improves cache locality and reduces read latency when the processor retrieves multiple records for batch evaluation processing.

The server generates a prompt sentence based on the stored response information. The server retrieves the response information from the information management area of the storage device, loads it into main memory, and combines it with a prompt template stored as configuration data.

The server maintains multiple prompt templates for different processing purposes, for example, a template for summary generation and a template for additional question generation. A concrete example of a prompt sentence for summary generation is:

“Please summarize the following applicant's answer in 2 sentences, focusing on motivation and skills:

The applicant has experience in data analysis and has successfully led a project.”

Another example of a prompt sentence for additional question generation is: “Based on the following applicant's answer, generate 5 additional interview questions to further assess the applicant's motivation and skills:

The applicant has experience in data analysis and has successfully led a project.” The server generates the prompt sentence by concatenating fixed instruction text with the retrieved response information and by inserting delimiters and formatting tokens. The server may further embed metadata, such as role descriptions or evaluation context, into the prompt sentence. By algorithmically constructing prompt sentences rather than manually crafting them, the server ensures consistency and reduces variability in the behavior of the generative AI model, which directly improves the reproducibility of AI-based evaluation results.

The server uses a generative AI model to transform the response information into structured evaluation data. In one embodiment, the generative AI model is implemented as a neural network language model with a transformer architecture. The transformer architecture comprises multiple encoder-decoder layers or decoder-only layers, each including multi-head self-attention mechanisms, feed-forward networks, normalization layers, and residual connections. The model parameters include a plurality of weight matrices and bias vectors associated with the attention layers and the feed-forward layers. These parameters are stored in a model parameter file on a computing node equipped with an accelerator, such as a general-purpose graphics processing unit, and are loaded into memory for inference execution.

The server sends the generated prompt sentence to the generative AI model through a model-serving interface. The server may host the generative AI model internally or may connect to an external model endpoint. The server serializes the prompt sentence into a request message and forwards it through an application programming interface. The generative AI model tokenizes the prompt sentence into token identifiers using a predefined tokenizer, maps the tokens into embeddings using learned embedding matrices, and propagates the embeddings through multiple attention and feed-forward layers. The model computes attention scores using dot-product operations on query, key, and value vectors, applies softmax normalization to obtain attention weights, and then computes weighted sums to produce contextualized token representations. The model then generates output token probabilities by applying a final linear transformation and a softmax function.

The generative AI model applies decoding logic, such as greedy decoding, beam search, or nucleus sampling, to select a sequence of output tokens that forms the generation result. The generation result includes at least one of summary information and additional question information. In the case of summary generation, the model compresses the semantic content of the response information into shorter text by learning from a training corpus where long-form inputs are associated with concise summaries. In the case of additional question generation, the model generates question sentences that aim to explore aspects indicated by the response information, such as missing details, unclear motivation, or partially described experience.

The server receives the generation result from the generative AI model and parses it into summary information and, when present, additional question information. The server stores the summary information into an evaluation information management area. The evaluation information management area may be realized as a separate table or a separate logical partition in the database, with fields such as “applicant_id,” “summary_text,” “summary_vector,” “evaluation_timestamp,” and “source_model_version.” The server may additionally compute a numerical vector representation of the summary information by applying a text embedding model or by reusing internal embeddings of the generative AI model. This numerical representation allows efficient similarity computation between summaries using vector operations, which improves performance for ranking and clustering of candidates.

The server compares the summary information with evaluation criterion information to calculate a quantitative index. The evaluation criterion information is stored as structured data in the storage device and can include target feature descriptions, threshold values, keyword lists, or prototype summary vectors. The server executes an evaluation algorithm that may combine rule-based scoring and vector-based similarity. For example, the server may compute a cosine similarity between the summary vector and a target profile vector, apply weights to specific dimensions corresponding to important skills or motivations, and then normalize the result to obtain a quantitative index score. The server may also count occurrences of designated keywords or phrases in the summary information and adjust the quantitative index accordingly.

The server thereby offloads complex semantic interpretation from human evaluators to the computing apparatus, but not as a mere automation of reading and scoring. Instead, the server restructures the data into compressed and feature-rich representations that are more amenable to machine processing. This restructuring reduces the volume of data required in main memory when comparing many candidates and enables the processor to use vectorized instructions and hardware acceleration to perform similarity computations. As a result, the system improves processing speed and scalability compared with systems where raw text is processed directly without intermediate summarization and embedding.

The server outputs the quantitative index and the additional question information to the terminal.

The terminal receives these outputs, decodes them, and renders them on the display. The user can view a list of candidates along with their summary information and quantitative indices, and can select additional question information for conducting follow-up interviews. The terminal may provide user interface components that sort and filter candidates based on the quantitative indices, thus enabling the user to identify candidates that meet or exceed certain evaluation thresholds.

The server manages evaluation history information by associating the quantitative index with the corresponding response information and summary information. The server writes entries to an evaluation history structure that may include fields such as “applicant_id,” “response_id,” “summary_id,” “index_value,” “classification_label,” “reliability_score,” and “evaluation_round.” The server uses this history information for subsequent evaluation processing, such as recalculating indices with updated evaluation criterion information or retraining auxiliary models for improved scoring.

The server can generate classification information and reliability information in addition to the quantitative index. In one embodiment, the server applies a classifier model, such as a logistic regression model or a neural network classifier, trained on pairs of summary information and ground truth labels (for example, “highly suitable,” “moderately suitable,” “not suitable”). The classifier computes class probabilities from input feature vectors derived from the summary information. The server interprets the probability associated with the predicted class as reliability information and stores both the classification label and the reliability value. By explicitly computing probabilistic measures, the system can prioritize cases with higher reliability and flag low-reliability cases for manual review, thereby reducing overall error rates and improving trustworthiness of the automated evaluation.

The server updates model parameters or evaluation criteria using the evaluation history information. In one embodiment, the server collects new labeled data from human evaluators, who may confirm or override AI-generated classification labels. The server uses this labeled data to perform supervised learning updates on auxiliary models, such as the classifier. The learning process may employ gradient-based optimization with a loss function, for example, cross-entropy between predicted probabilities and true labels. The server updates model weights iteratively by computing gradients with respect to the loss function and adjusting the weights using a learning rate parameter. The server may also apply regularization techniques and data augmentation techniques, such as synonym replacement or paraphrasing of text, to improve generalization performance.

The generative AI model itself may be trained or fine-tuned using evaluation history information.

The server prepares training pairs composed of prompt sentences and desired outputs, such as ideal summary information or ideal additional question information. The server feeds these pairs to a training module, which performs backpropagation through the transformer network. The training module computes a loss function, such as a token-level cross-entropy between generated token distributions and ground truth tokens, computes gradients, and updates the model parameters. The server may schedule training processes at times of low load to avoid interference with inference operations. By systematically updating the generative AI model using evaluation history, the system adapts model behavior to domain-specific requirements, which leads to improved precision and relevance of generated summaries and questions.

The system provides technical effects that go beyond mere automation of human tasks. The server reduces communication load between the terminal and the server by transmitting compact summaries and indices instead of large raw response texts when performing certain operations, such as lists of candidates or aggregated reports. The server improves computational efficiency by storing and processing compressed summary vectors for similarity searches and ranking, allowing the use of efficient linear algebra routines optimized for modern processor and accelerator architectures. The server improves evaluation precision by combining neural network outputs with structured evaluation criterion information and history-based calibration, which reduces variability and bias compared with ad hoc human judgment or naive keyword matching.

The server implements non-conventional data flows and control flows that are different from traditional rule-based filtering systems. For example, the server uses a sequence of transformations: raw response information→prompt sentence→generative model output→summary vector→quantitative index→evaluation history entry. Each transformation is designed with specific data structures and algorithms that permit efficient reuse and re-evaluation. This pipeline contrasts with conventional systems that operate directly on raw text or that use fixed question templates with static scoring rules. The use of a generative AI model in an iterative pipeline allows the system to generate new prompts conditioned on earlier AI outputs, which enables multi-stage refinement of evaluations that would be technically impractical with fixed-rule systems.

Alternative embodiments can vary implementation details while remaining within the scope of the invention. The server may use different types of generative AI models, such as encoder-decoder transformer models or recurrent neural network-based models, and may adjust hyperparameters, such as the number of layers, the dimensionality of embeddings, the number of attention heads, and dropout rates. The server may store data in different kinds of storage devices, including distributed databases or in-memory databases, to improve throughput or reduce latency. The server may expose different application interfaces, such as message-based interfaces or streaming interfaces, to adapt to various deployment environments.

The server may implement different evaluation algorithms. In one variant, the server uses semantic hashing to convert summary information into compact binary codes and performs Hamming distance comparisons for high-speed candidate retrieval. In another variant, the server applies clustering algorithms on summary vectors to group evaluation target persons into clusters and adjusts evaluation criteria dynamically per cluster. The server may also generate multiple candidate summaries or additional question sets and select one based on internal scoring rules, such as language fluency scores, coverage scores, or alignment scores with evaluation criteria.

The terminal can take different forms. In one embodiment, the terminal is a thin client that primarily renders user interfaces and forwards raw text to the server. In another embodiment, the terminal performs preliminary processing, such as local text pre-checking or encryption, before sending data to the server. The terminal may also locally cache summary information and quantitative indices to enable offline browsing and synchronization with the server when network connectivity is restored.

The user can interact with the system in different ways. The user may configure evaluation criterion information through a dedicated administration interface. The user may select from multiple model configurations or scoring profiles depending on the type of role or domain involved. The user may also provide feedback on AI-generated summaries and additional questions, marking them as “accurate” or “inaccurate,” and the server may incorporate these feedback signals into the evaluation history for improving subsequent model updates.

Through these embodiments, the server, the terminal, and the user cooperate within a structured system. The server transforms raw, unstructured response information into structured, machine-usable evaluation artifacts via controlled interactions with a generative AI model using programmatically generated prompt sentences. These transformations enable enhanced data management, computational efficiency, and evaluation consistency at the level of computer architecture and algorithm design, thereby implementing an improvement in computer technology rather than merely automating a human mental process.

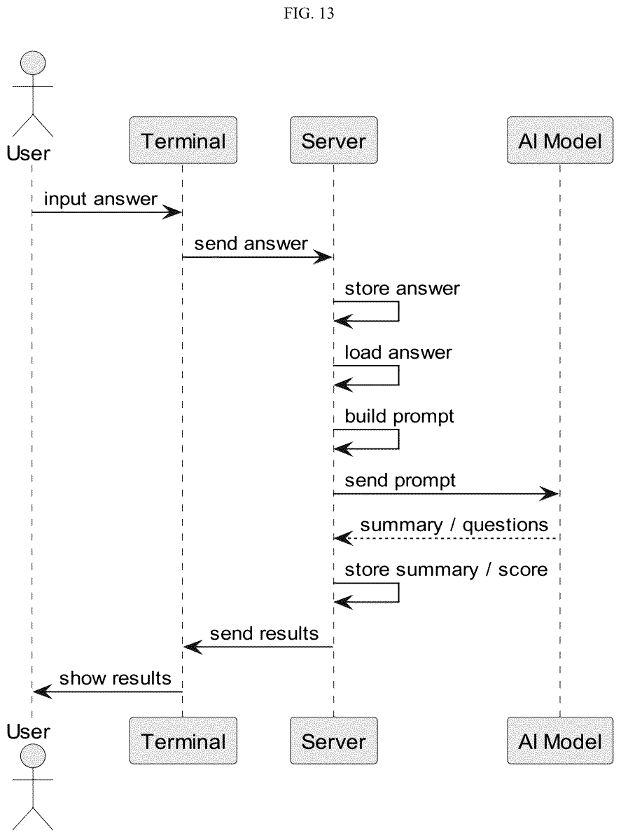

The following describes the processing flow using FIG. 13.

### Step 1

The user operates the terminal to input response information of an evaluation target person.

The terminal displays an input screen including a text field for entering free-form responses and controls for identifying the evaluation target person.

The input is natural-language text entered by the user (for example, “The applicant has experience in data analysis and has successfully led a project.”) together with identifier information (for example, an applicant ID).

The terminal converts the input into encoded text data using a character encoding scheme, combines it with the identifier information into a structured message, and outputs a request to the server via a communication network.

### Step 2

The server receives the request from the terminal via an input/output interface.

The input is structured request data that includes the applicant identifier and the response text.

The server parses the request data, validates fields such as length and encoding, and normalizes whitespace or control characters in the response text.

The server writes the normalized response text and associated identifiers into a storage device, outputting a new database record or similar stored object representing the response information.

### Step 3

The server retrieves stored response information from the storage device for evaluation processing.

The input is a query condition, such as a specific applicant identifier or a list of applicant identifiers to be processed.

The server executes a database access operation that reads one or more records of response information into main memory.

The server outputs in-memory data structures that contain at least the response text string and the corresponding identifiers, ready for further processing.

### Step 4

The server generates a prompt sentence for a generative AI model based on the retrieved response information.

The input is the response text and optional metadata (for example, role type or evaluation context) held in memory.

The server selects a prompt template corresponding to a desired operation, such as summary generation or additional question generation, and performs string concatenation and token insertion to embed the response text into the template.

The server outputs a completed prompt sentence, for example:

“Please summarize the following applicant's answer in 2 sentences, focusing on motivation and skills:

The applicant has experience in data analysis and has successfully led a project.”

### Step 5

The server sends the generated prompt sentence to a generative AI model.

The input is the prompt sentence string and model invocation parameters (such as model identifier, maximum output length, and decoding strategy).

The server wraps the prompt sentence and parameters into a model request message and transmits it to an internal or external model-serving endpoint via a network interface.

The server outputs a model request and awaits a generation result, creating a pending task or similar control structure to track the request.

### Step 6

The server obtains a generation result from the generative AI model.

The input is the response message returned by the generative AI model, which contains generated text data.

The server parses the response message, extracts generated content, and distinguishes between summary information and additional question information according to a predefined format or markers.

The server outputs separate textual elements, such as a summary string and, when present, a list of additional question strings (for example, five generated follow-up questions).

### Step 7

The server stores summary information and optional additional question information in the storage device.

The input is the generated summary string, any additional question strings, and identifiers for the corresponding evaluation target person.

The server creates or updates records in an evaluation information management area, linking the summary and questions to the original response information using keys such as applicant ID and response ID.

The server outputs persistent records that can be retrieved later for display, comparison, and scoring.

### Step 8

The server calculates a quantitative index based on the summary information and evaluation criterion information.

The input is the summary text (and optionally a numerical representation of the summary) together with evaluation criterion information stored in the storage device.

The server processes the summary text using one or more algorithms, such as keyword matching, semantic embedding computation, and similarity scoring, and compares the resulting features against target profiles or thresholds defined by the evaluation criterion information.

The server outputs a numerical value representing a quantitative index of suitability for the evaluation target person, normalized or scaled according to a predefined scoring scheme.

### Step 9

The server associates the quantitative index with the corresponding response information and summary information to form evaluation history information.

The input is the quantitative index, identifiers of the response record and the summary record, and optional classification or reliability information.

The server writes an evaluation history entry into the storage device, storing cross-references among response, summary, index, and any auxiliary evaluation attributes.

The server outputs a structured history record that can be accessed for later analysis, model calibration, or re-evaluation.

### Step 10

The server transmits evaluation results to the terminal.

The input is a retrieval request from the terminal specifying one or more evaluation target persons and the associated evaluation history entries stored in the storage device.

The server aggregates summary information, quantitative indices, and optional additional question information into a response message and formats the data for efficient transmission.

The server outputs a response containing, for each evaluation target person, at least the summary text and quantitative index, and optionally classification labels, reliability scores, and generated additional questions.

### Step 11

The terminal receives the evaluation results from the server and presents them to the user.

The input is the response message containing summaries, indices, and optionally additional questions.

The terminal parses the received data, constructs data structures for display, and renders a user interface that lists evaluation target persons together with their summary information and quantitative indices.

The terminal outputs a visual presentation on a display device, enabling the user to review, sort, and compare multiple evaluation target persons and to inspect any additional question information for use in further interviews.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented interview and evaluation systems suffer from several technical limitations in how they process, integrate, and utilize heterogeneous data such as natural language answers, audio signals, and image information. Typical systems either rely on simple rule-based logic or isolated machine learning components that operate on pre-defined inputs. As a result, such systems exhibit rigid behavior that is difficult to adapt to different evaluation tasks, produce inconsistent or non-transparent scoring, and underutilize available multimodal data, leading to sub-optimal accuracy and reliability in automated evaluation.

In particular, in many existing systems, a text analysis engine, a speech recognition engine, and an emotion analysis engine are wired together by static application code. The application logic must be manually redesigned whenever the evaluation task changes (for example, from question generation to answer summarization or consistency scoring). This fixed integration pattern creates a technical bottleneck: the computing resources of a generative information processing model, such as a large-scale neural language model, cannot be efficiently reused across multiple subtasks, and the system cannot dynamically adapt to different output formats or evaluation criteria without substantial redevelopment. Furthermore, these systems often treat prompt sentences to such models as hard-coded strings scattered throughout the application, making it difficult for the processor to systematically manage, reuse, or evolve the interaction patterns with the model.

Additionally, conventional systems typically process speech, text, and image data as separate streams and only combine their outputs at a late stage through simplistic weighting. This loose coupling prevents the processor from computing evaluation values that properly reflect the interdependence between content-based scores and emotion-based indicators. In particular, inconsistency between an applicant's verbal content and detected emotional state is not systematically captured and quantified, resulting in unreliable scoring that can fluctuate unpredictably across sessions and devices.

Yet another technical problem is the lack of traceability and structured representation of the evaluation process. Known systems often output only a final score or brief comment, without preserving a machine-readable link between each score, the underlying prompt sentences provided to the generative model, and the intermediate results such as summaries, consistency values, and emotion metrics. As a consequence, it is difficult for downstream computing systems to audit or reuse these intermediate artifacts, and difficult for the system itself to refine or debug its evaluation pipeline.

Therefore, there is a need for a computer-implemented system and method that (i) centrally manages prompt sentences and template information for a generative information processing model, (ii) dynamically constructs task-specific prompt sentences using runtime data, (iii) tightly integrates content-based and emotion-based computations into unified evaluation value information, and (iv) records machine-readable, traceable evaluation processes. Such a system should improve the functioning of the processor by enabling more flexible, data-driven control over different subtasks (question generation, summarization, consistency measurement, reliability and aptitude scoring) without hard-coding separate logic for each task, thereby providing more stable, accurate, and transparent automated evaluations.

The specific processing by the specific processing unit 290 of the data processing device 12 in Application Example 2 is realized by the following means.

The present invention provides a server comprising a processor configured to generate, using a generative information processing model, prompt sentences for multiple tasks including question generation, answer summarization, consistency evaluation, reliability evaluation, and aptitude evaluation; to dynamically construct the prompt sentences at runtime based on template information and input data including reference person information, reference condition information, answer information, and emotion state information; to acquire audio information and image information of a subject from a terminal device, convert the audio information into character information via a recognition processing device, and store the character information as answer information; to execute natural language processing on the answer information so as to extract key point information, generate summary information, and compare the answer information with the reference person information or the reference condition information to calculate consistency information and numerical evaluation value information; to input the audio information and the image information of the subject to an emotion estimation processing device so as to estimate emotion state information based on acoustic feature information and visual feature information, and to integrate the emotion state information into the evaluation value information to compute reliability information and aptitude information; to record, in association with the subject, the evaluation value information, the reliability information, the aptitude information, and explanation sentence information generated by the generative information processing model; and to output interview evaluation information including the recorded information and selection result information or recommended action information to at least one of the terminal device, a display device, or an external information processing device. This enables the server to centrally manage and orchestrate heterogeneous processing components and generative model interactions through structured and dynamically generated prompt sentences, thereby improving the technical performance of the interview and evaluation pipeline in terms of adaptability to different tasks, efficient reuse of the generative model across subtasks, consistent fusion of multimodal content and emotion signals into unified evaluation values, and traceable recording of intermediate and final evaluation artifacts for reliable and auditable automated decision support.

The term “system” refers to a combination of hardware resources and software resources that cooperate to execute the processing described in the claims, including at least one server-side apparatus and one or more terminal-side apparatuses connected via a communication network.

The term “server” refers to an information processing apparatus including at least one processor, a memory, and an interface device, the apparatus being configured to execute programs that implement the generation of prompt sentences, the interaction with a generative information processing model, and the computation and output of evaluation information.

The term “processor” refers to a hardware processing unit, such as a central processing unit or a programmable logic device, that executes program instructions to perform arithmetic operations, logical operations, control operations, and data transfer operations required by the present invention.

The term “terminal device” refers to an end-user information processing apparatus, such as a portable information terminal or a desktop information terminal, that is configured to capture audio information and image information of a subject, present questions and evaluation results, and communicate with the server over a communication network.

The term “generative information processing model” refers to a trained computational model that performs probabilistic inference or prediction on sequence data, such as a neural language model, and that is capable of generating text outputs, including prompt responses, questions, summaries, or evaluation comments, in response to text inputs.

The term “prompt sentence” refers to a textual instruction or query string provided as input to the generative information processing model, the string specifying a task to be performed by the model and defining at least one condition, constraint, or output format required for the task.

The term “template information” refers to predefined data structures or text patterns that specify a format of prompt sentences or other generated texts, the patterns including one or more insertion positions for variables, and being used by the processor to construct concrete prompt sentences at runtime.

The term “motivation information” refers to information indicating reasons, intentions, or goals expressed by a subject in relation to a target role, activity, or entity.

The term “capability information” refers to information indicating skills, knowledge, experience, or other abilities possessed by a subject in relation to a target role or task.

The term “subject” refers to a person that is evaluated by the system, including an applicant, a user, or any other evaluation target whose answers and behavior are processed by the server.

The term “audio information” refers to digital data representing sound captured from the subject, including but not limited to spoken utterances during an interview or dialog session.

The term “image information” refers to digital data representing visual content captured from the subject, including but not limited to still images or video frames of the subject's face and body.

The term “recognition processing device” refers to a hardware and software component, local or remote, that receives audio information and outputs corresponding character information by executing a speech recognition process.

The term “character information” refers to symbolic data representing text, such as sequences of characters or tokens, obtained by converting audio information through speech recognition or received directly as text input.

The term “answer information” refers to character information that represents a response of the subject to at least one question presented by the system, and that is stored and used as an input for further processing.

The term “question generation” refers to a process in which the processor obtains, from the generative information processing model, at least one question text that is to be presented to the subject, based on a prompt sentence and optionally additional context data.

The term “follow-up question” refers to a second or subsequent question generated in dependence on content of previous answer information, the question being intended to obtain additional or more detailed information from the subject.

The term “natural language processing” refers to a set of computational techniques for analyzing, transforming, or generating human language text, including but not limited to tokenization, part-of-speech tagging, parsing, semantic analysis, and information extraction.

The term “key point information” refers to extracted data that represents main elements or salient aspects of the answer information, identified by the processor through natural language processing or other data reduction techniques.

The term “summary information” refers to condensed character information that expresses, in a shorter form, the essence of the answer information, including at least part of the key point

The term “reference person information” refers to data representing a target profile of an ideal or reference person, including desired capabilities, experiences, and behavioral characteristics used as a comparison standard.

The term “reference condition information” refers to data representing one or more target conditions, criteria, or thresholds for evaluation, defined independently of a specific individual, and used to compare against answer information.

The term “consistency information” refers to data indicating a degree of similarity, correspondence, or match between answer information and at least one of the reference person information and the reference condition information.

The term “evaluation value information” refers to numeric or symbolic data representing a quantitative assessment derived from the consistency information, and optionally from other factors, for at least one evaluation item.

The term “emotion estimation processing device” refers to a hardware and software component, local or remote, that receives at least one of audio information and image information and outputs emotion state information by applying pattern recognition or machine learning techniques.

The term “acoustic feature information” refers to numerical descriptors extracted from audio information, including at least one of pitch, energy, spectral distribution, and temporal prosody characteristics.

The term “visual feature information” refers to numerical descriptors extracted from image information, including at least one of facial landmarks, facial expression patterns, gaze direction, and body posture characteristics.

The term “emotion state information” refers to data indicating at least one emotional category, such as joy, anxiety, confidence, or neutrality, and optionally an intensity or probability associated with each category, derived from the acoustic feature information and the visual feature information.

The term “reliability information” refers to data indicating a degree of trustworthiness or internal consistency of the subject's responses, computed based on at least the evaluation value information and the emotion state information.

The term “aptitude information” refers to data indicating a degree of suitability of the subject for a target role or condition, computed based on at least the evaluation value information and optionally adjusted by the emotion state information.

The term “interview evaluation information” refers to aggregated data for a session with the subject, including at least the evaluation value information, the reliability information, the aptitude information, and optionally associated explanation sentence information.

The term “selection result information” refers to data indicating a decision outcome regarding the subject, such as recommendation to proceed, rejection, or other classification, derived from at least one of the evaluation value information and the reliability information.

The term “recommended action information” refers to data indicating at least one suggested operation to be performed in response to the evaluation of the subject, such as initiating a follow-up interview, assigning training, or notifying another system.

The term “external information processing device” refers to an information processing apparatus separate from the server and the terminal device, such as a management system or analysis system, that receives at least a part of the interview evaluation information, the selection result information, or the recommended action information.

The term “explanation sentence information” refers to character information generated by the generative information processing model or by deterministic processing, the information describing reasons or bases for at least one evaluation value, reliability measure, or aptitude measure in a natural language form.

The term “comprehensive evaluation value information” refers to evaluation value information that results from combining, by weighting or other aggregation procedures, a plurality of evaluation values and reliability measures over multiple evaluation items.

The term “evaluation item” refers to a defined aspect or dimension with respect to which the subject is assessed, such as motivation, technical capability, communication skill, or emotional stability.

The term “traceable manner” refers to a recording mode in which intermediate data, including prompt sentences, model outputs, and partial scores, are stored in association with identifiers that allow reconstruction of the sequence of processing steps leading to final evaluation results.

In one or more embodiments, a server executes an interview and evaluation program that implements the claimed system. The server includes at least one processor, a main memory, a non-volatile storage device, and a network interface. The processor executes machine-readable instructions stored in the memory to perform multimodal acquisition, generative text processing, emotion estimation, and integrated scoring as described below. The server may be implemented on a general-purpose computer platform equipped with a multi-core central processing unit and optionally one or more graphics processing units configured to accelerate neural network inference. The server communicates with at least one terminal over a communication network such as a packet network.

The terminal operates as a user-facing device. The terminal may be realized by a handheld portable information processing device, a wearable information processing device, or a stationary information processing device. The terminal includes at least one input device such as a microphone and a camera, a display device such as a liquid crystal or organic light-emitting display, a local processor, a memory, and a network interface. The terminal executes an application program that presents questions to a user, captures audio information and image information of the user, and exchanges structured data with the server.

The user interacts with the system by operating the terminal. The user provides spoken answers via the microphone and visual expressions via the camera. The user also views generated questions, summaries, scores, and recommendations on the display. The user may be an applicant in a personnel selection scenario, or another subject whose characteristics are being evaluated.

In one embodiment, the server uses a generative AI model as a generative information processing model. The generative AI model is implemented as a deep neural network, such as a transformer-based language model consisting of multiple layers of self-attention blocks and feed-forward blocks. The model receives tokenized text as input and outputs probability distributions over subsequent tokens. The server fine-tunes or configures the generative AI model to perform multiple tasks including question generation, answer summarization, consistency evaluation, reliability evaluation, and aptitude evaluation, all through prompt sentences.

The server stores template information representing different types of prompt sentences. The template information is held in a data structure such as a template table in a relational database or a key-value store. Each template entry includes a template identifier, a textual template string containing placeholder tokens, and metadata describing the intended task and expected output format. For example, the server may store:

Template for question generation:

“Act as an AI interviewer. Position: {position}. Generate one question about the candidate's motivation and one question about the candidate's key skills.”

Template for answer summarization:

“Summarize the following answer in one or two short sentences, focusing on the main strengths.

Answer: ‘{answer_text}’.”

Template for consistency evaluation:

“Ideal candidate profile: {profile_text}. Applicant answer: {answer_text}. Compare the answer with the profile and output: (1) a match score from 0 to 100, and (2) a brief explanation.”

Template for emotion-aware reliability:

“Answer text: ‘{answer_text}’. Detected emotion: {emotion_label} with intensity {emotion_value}. (1) Summarize the answer. (2) Evaluate how consistent the emotion is with the content. (3) Provide a reliability score from 0 to 100 and a short justification.”

The server dynamically constructs a concrete prompt sentence at runtime by retrieving an appropriate template and replacing placeholder tokens with context-specific values. The server manages these templates centrally, which allows the processor to modify interaction patterns with the generative AI model without changing low-level application code. This structure improves data management and reduces configuration errors, thereby enhancing the reliability and maintainability of the system.

The server employs multiple software modules to implement the above functions. The server uses a speech recognition module, which may be a cloud-based speech-to-text service or an on-premise speech recognizer, to convert audio information received from the terminal into character information. The speech recognition module implements acoustic models and language models, for example a deep neural network acoustic model and a statistical language model, to decode waveform data into text. The server also uses a natural language processing library, such as a tokenizer and named entity recognizer, to normalize and enrich the character information.

The server uses an emotion estimation processing module to compute emotion state information.

In one embodiment, the server uses a convolutional neural network for image-based emotion detection. The convolutional neural network receives image information representing the user's face and outputs predicted probabilities of emotion categories. The network may be trained using supervised learning on a labeled dataset of facial expressions. The server also uses a feature extraction module to compute acoustic feature information such as fundamental frequency, energy contours, and spectral features from the audio information. The server concatenates or otherwise fuses the visual feature information and acoustic feature information, and feeds them to a multimodal classifier neural network that outputs emotion state information consisting of emotion labels and intensities.

The server assigns intermediate results to structured data fields. The server stores answer information, summary information, consistency information, evaluation value information, emotion state information, reliability information, and aptitude information in an evaluation record associated with a session identifier and a subject identifier. Each evaluation record contains fields for each evaluation item, such as “motivation,” “leadership,” “technical skill,” and “communication.” The server uses a well-defined schema so that downstream systems can interpret the results in a machine-readable manner.

The server defines internal algorithms for computing evaluation values. In one embodiment, the server receives from the generative AI model a match score and explanation for each answer relative to a reference profile. The server normalizes each match score into a numeric value between 0 and 1 and aggregates multiple scores using a weighted average. The server assigns different weights for different evaluation items according to their importance for the target position. For example, the server may assign weight 0.5 for leadership, 0.3 for domain knowledge, and 0.2 for communication. The server calculates a comprehensive evaluation value information as a weighted sum. To compute reliability information, the server uses both the emotion state information and the content-based scores. If the generative AI model returns a low emotion-content consistency score, the server reduces the reliability for that item by a factor, such as multiplying by a reliability scaling coefficient less than 1. This explicit rule-based adjustment ensures that content and emotion are fused in a non-trivial, predefined manner and not simply averaged.

The server predefines evaluation rules for different scenarios. For instance, when the emotion state information indicates high positive valence and high arousal during segments where the user expresses interest in the role, the server increases a motivation-related aptitude information value. When the emotion state information indicates conflicting emotional signals, such as negative affect during claims of enthusiasm, the server lowers reliability information for the motivation item. These explicit rules implement non-conventional, non-human evaluation logic that allows the system to respond to patterns that are difficult for human evaluators to consistently perceive.

The server uses the generative AI model not as a monolithic black box but as a configurable component whose behavior is controlled by structured prompt sentences and template information. The server provides explicit task descriptions and output formatting instructions in each prompt sentence so that the model behaves deterministically within a constrained range. For example, the server instructs the model to always output a specific label such as “Score:” followed by a numeric value, enabling the server to parse model outputs reliably. In this way, the generative AI model functions as part of a deterministic pipeline where each output is parsed and stored into predefined fields.

The server can employ different neural network architectures for the generative AI model. In one example, the generative AI model is a transformer encoder-decoder network with multiple attention heads per layer and layer normalization. The model is trained using maximum likelihood estimation on a large corpus of language sequences. The server may fine-tune the model on task-specific data consisting of example prompt sentences and desired outputs such as structured evaluations. During training, the model minimizes a loss function such as cross-entropy between predicted token distributions and target tokens. The server may apply regularization techniques, such as dropout, and optimization algorithms, such as stochastic gradient descent with adaptive moment estimates, to update the network weights. In another example, the server uses a decoder-only transformer network specialized for conditional text generation.

The server stores and processes intermediate model outputs in a structured manner to achieve technical improvements. When the server obtains a summary from the generative AI model, the server stores it as summary information together with references to the corresponding answer information and prompt sentence. This structure allows the server to reuse summary information for multiple downstream tasks, such as displaying a concise review to a user or feeding the summary into another prompt sentence for generating evaluation comments. By reusing intermediate representations, the server reduces redundant calls to the generative AI model, thereby decreasing computation load and latency. This contributes to improved processing speed and reduced communication overhead between the server and external model containers.

The server employs specific data flows and module compositions that lead to measurable technical effects. The server reduces latency by performing audio preprocessing and feature extraction in a pipelined fashion, where the server starts sending partial audio segments to the speech recognition module before the entire answer is recorded. The server in parallel computes acoustic feature information for emotion estimation, allowing overlapping processing of recognition and emotion analysis. This concurrency reduces end-to-end response time for generating follow-up questions and updated evaluation metrics. The server also compresses audio and image streams using perceptual compression algorithms before sending them to remote services, thereby reducing network bandwidth consumption without materially degrading recognition accuracy.

The terminal plays an active role in the technical architecture. The terminal may perform initial audio conditioning, such as noise reduction and automatic gain control, using digital signal processing on its local processor. The terminal may also perform local face detection to crop image regions of interest before uploading them to the server, which reduces the volume of image data sent over the network. The terminal encodes user identifiers and session identifiers in protocol messages, so that the server can correctly associate incoming audio and image information with the appropriate evaluation record. These technical measures at the terminal side contribute to efficient, accurate, and synchronized processing in the server.

The user benefits from the system's improved computer-implemented functionality. When the user answers questions, the user receives follow-up questions in near real time due to the system's optimized pipeline and efficient reuse of generative AI model resources. The user sees evaluation scores and explanations that reflect a sophisticated integration of language content and emotional cues, which could not be replicated by simple rule-based systems. The user can also see a structured breakdown of evaluation into multiple items, each with a generated explanation sentence, which provides a transparent view of how the system reached its conclusions.

In one exemplary use case, the server receives from the terminal answer information: “I have five years of experience managing software development projects and I enjoy leading cross-functional teams.” The server constructs a prompt sentence for summarization:

“Summarize the following answer in one sentence focusing on leadership and teamwork strengths. Answer: ‘I have five years of experience managing software development projects and I enjoy leading cross-functional teams.’”

The generative AI model outputs: “The applicant has strong leadership and teamwork experience managing software development projects for five years.”

The server stores this as summary information and uses it in another prompt sentence for consistency evaluation:

“Ideal candidate profile: Strong leadership, at least three years of project management experience, and ability to collaborate across functions. Applicant answer: The applicant has strong leadership and teamwork experience managing software development projects for five years. Compare the answer with the profile and output: (1) a match score from 0 to 100, and (2) a brief explanation.”

The server parses the model's output, for example, “Score: 92. Explanation: The applicant exceeds the required project management experience and demonstrates cross-functional leadership,” and stores a numeric score 92 as evaluation value information for the relevant item.

In another exemplary use case, the server uses emotion state information. When the user states, “I am very excited about this opportunity,” the terminal sends corresponding audio and image information. The server extracts acoustic feature information showing increased pitch and energy and visual feature information indicating a genuine smile. The emotion estimation processing device outputs emotion state information such as “joy” with intensity 0.9. The server then constructs the following prompt sentence:

“Answer text: ‘I am very excited about this opportunity.’ Detected emotion: joy with intensity 0.9. (1) Summarize the answer. (2) Evaluate how consistent the emotion is with the content. (3) Provide a reliability score from 0 to 100 and a short justification.”

The generative AI model may respond: “Summary: The applicant expresses strong enthusiasm for the opportunity. Consistency: High. Reliability score: 88. Justification: The verbal content and detected joyful emotion strongly align.” The server converts the reliability score to a numeric value and increases the aptitude information for motivation accordingly. This integrated processing provides a more nuanced and technically sophisticated evaluation compared to simple text-only or emotion-only approaches.

In additional embodiments, the server can support alternative configurations of the generative AI model and emotion estimation processing device. The server can switch between different generative model versions depending on resource constraints or desired accuracy levels. The server can also employ different multimodal fusion strategies, such as late fusion where separate emotion and content scores are merged at the last stage, or early fusion where emotion embeddings are concatenated with textual embeddings within a neural architecture. By explicitly controlling these strategies in software and by recording their configurations with evaluation outputs, the server enables systematic optimization of computational efficiency and accuracy.

In yet another embodiment, the server provides an interface for updating template information and transformation rules while preserving backward compatibility. The server may store version identifiers for each template and maintain a mapping from older evaluation records to template versions used at the time of processing. This data management scheme allows longitudinal analysis and ensures that adjustments to prompt sentences or scoring rules do not corrupt historical data. This contributes to improved data integrity and traceability, which in turn facilitates debugging and fine-tuning of the technical system.

Overall, the described embodiments focus on concrete improvements to computer technology.

The server, terminal, and user cooperate in a specific architecture that uses prompt-sentence-driven generative AI models, multimodal signal processing, and structured evaluation records. The architecture enables faster response times through pipelined processing, higher accuracy through integrated content-emotion evaluation, reduced communication load by selective feature extraction and compression, and better transparency by recording intermediate artifacts in a traceable manner. These improvements go beyond mere automation of human decision making and instead modify and enhance the way computing devices process, combine, and manage heterogeneous data to perform technically complex evaluation tasks.

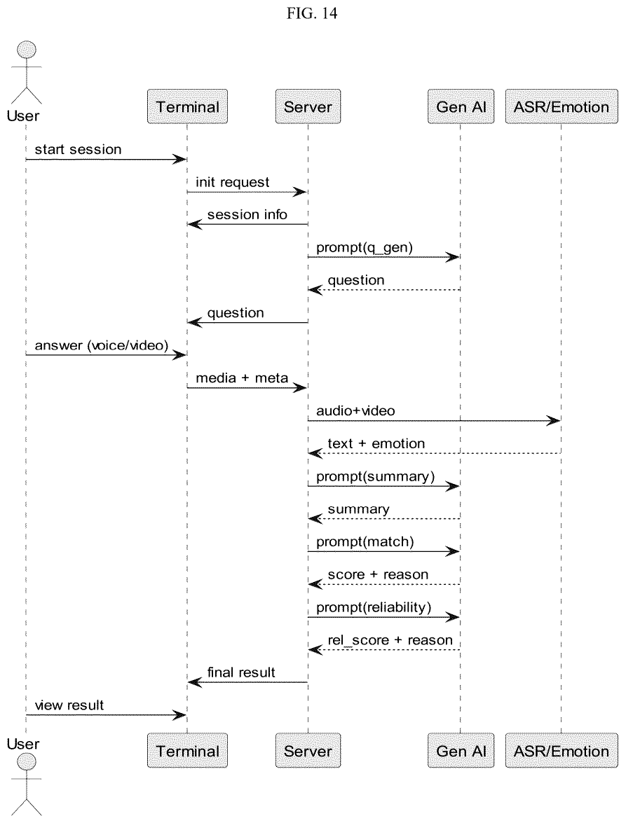

The following describes the processing flow using FIG. 14.

### Step 1

Server initializes an evaluation session.

Server receives, as input, a session start request from the terminal including at least a subject identifier, a target role identifier, and optional reference profile information.

Server allocates a new session record in a database, assigns a session identifier, and stores the received metadata.

Server outputs the session identifier and initial configuration parameters (for example, required evaluation items and language settings) to the terminal.

Server thereby performs data initialization and creates internal data structures (such as in-memory objects or database rows) used in subsequent processing.

### Step 2

Terminal prepares the user interface for the session.

Terminal receives, as input, the session identifier and configuration parameters from the server.

Terminal configures its user interface according to the parameters, requests permission to access a microphone and a camera from the operating system, and prepares audio and video capture modules.

Terminal outputs a ready-state screen to the user indicating that the session has started and that the terminal is prepared to present questions and capture responses.

### Step 3

User provides initial profile information.

User receives, as input, the ready-state screen and optional text fields for name, role, or background.

User enters profile information via keyboard or touch input and confirms the entries.

User outputs profile information to the terminal by activating a send or next control on the screen.

### Step 4

Terminal transmits profile information to the server.

Terminal receives, as input, the profile information submitted by the user and the session identifier.

Terminal packages the information into a structured message (for example, a JSON or form-encoded payload) and sends it over a network connection to the server using a secure protocol.

Terminal outputs a transmission acknowledgment screen to the user and waits for the next instruction from the server.

### Step 5

Server generates an initial question prompt sentence for the generative AI model.

Server receives, as input, the profile information and the session identifier.

Server retrieves template information for a question-generation prompt sentence, inserts variables such as target role and key competencies, and constructs a concrete prompt sentence.

For example, the server generates:

“Act as an AI interviewer. Position: Project Manager. Generate one question about the candidate's motivation and one question about the candidate's key skills.”

Server outputs the constructed prompt sentence as input to the generative AI model and stores a copy in association with the session record.

### Step 6

Server generates initial questions using the generative AI model.

Server receives, as input, the question-generation prompt sentence from Step 5.

Server sends the prompt sentence to the generative AI model, which processes tokenized text through its neural network layers and outputs a sequence of tokens representing one or more questions.

Server decodes the token sequence into text, performs text normalization (for example, trimming whitespace and correcting basic punctuation), and stores the resulting question texts in the session record.

Server outputs the generated questions to the terminal with associated question identifiers.

### Step 7

Terminal presents questions to the user.

Terminal receives, as input, the question texts and their identifiers from the server.

Terminal renders the questions on the display, optionally using different visual styles to distinguish primary questions from follow-up questions, and prepares input controls for speech or text responses.

Terminal outputs the displayed questions and an active input interface to the user.

### Step 8

User provides an answer using speech or text.

User receives, as input, the displayed question.

User presses a record button and speaks the answer into the microphone, or types the answer into a text input field.

User outputs the answer as an audio stream or as character information to the terminal by confirming submission.

### Step 9

Terminal captures and pre-processes audio and image information.

Terminal receives, as input, the user's spoken answer and any concurrent video captured by the camera.

Terminal applies audio pre-processing such as noise reduction and automatic gain control, and optionally compresses the audio using a codec. For image information, terminal may perform face detection and crop the region of interest.

Terminal outputs pre-processed audio information, optional image information, and associated metadata (question identifier, timestamps, session identifier) to the server via a network connection.

### Step 10

Server converts audio information to character information.

Server receives, as input, the pre-processed audio information, metadata, and optional raw text answers from the terminal.

Server forwards the audio information to a speech recognition module, which applies acoustic models and language models to decode the waveform into text. Server receives recognized text and confidence scores, then performs text cleaning operations such as removing noise tokens and standardizing punctuation.

Server outputs character information representing the user's answer and stores it as answer information linked to the session and question identifiers.

### Step 11

Server generates a prompt sentence for answer summarization.

Server receives, as input, the answer information and related metadata.

Server retrieves a summarization template, inserts the answer text into the placeholder, and constructs a concrete prompt sentence, for example:

“Summarize the following answer in one or two short sentences, focusing on the main strengths.

Answer: ‘I have five years of experience managing software development projects and I enjoy leading cross-functional teams.’”

Server outputs the summarization prompt sentence as input to the generative AI model and records a link between the prompt and the answer information.

### Step 12

Server generates summary information using the generative AI model.

Server receives, as input, the summarization prompt sentence from Step 11.

Server sends the prompt sentence to the generative AI model, which computes a probability distribution over tokens and outputs a condensed text representation.

Server decodes and normalizes the output, thereby obtaining summary information that captures key points, and stores this information with references to the original answer.

Server outputs the summary information to be optionally displayed on the terminal or used in further evaluation computations.

### Step 13

Server generates a prompt sentence for consistency evaluation against a reference profile.

Server receives, as input, the summary information, the answer information, and reference profile information or reference condition information stored for the session.

Server retrieves a consistency-evaluation template and substitutes placeholders with the current profile and answer content, for example:

“Ideal candidate profile: Strong leadership, at least three years of project management experience, and ability to collaborate across functions. Applicant answer: The applicant has strong leadership and teamwork experience managing software development projects for five years. Compare the answer with the profile and output: (1) a match score from 0 to 100, and (2) a brief explanation.”

Server outputs the constructed consistency-evaluation prompt sentence to the generative AI model.

### Step 14

Server computes evaluation value information from the generative AI model output.

Server receives, as input, the consistency-evaluation prompt sentence and sends it to the generative AI model.

Server receives as output a text that includes a numeric match score and an explanation. Server parses the output text to extract the numeric score (for example, reading the number following “Score:”) and converts it into an internal numeric representation between 0 and 1 or 0 and 100.

Server outputs evaluation value information for the corresponding evaluation item and stores both the numeric score and the explanation in the evaluation record.

### Step 15

Server estimates emotion state information from audio and image information.

Server receives, as input, the pre-processed audio information and image information associated with the answer.

Server computes acoustic feature information, such as pitch contours and energy, using signal processing algorithms, and extracts visual feature information, such as facial landmarks and expression patterns, using a vision processing library. Server provides these features to an emotion estimation processing module, which outputs emotion labels and intensity values.

Server outputs emotion state information (for example, “joy, 0.9”) and stores it with the session and question identifiers.

### Step 16

Server generates a prompt sentence for emotion-aware reliability evaluation.

Server receives, as input, the answer information and the emotion state information.

Server retrieves an emotion-aware reliability template and inserts the answer text, emotion label, and intensity into the placeholders. For example, the server constructs:

“Answer text: ‘I am very excited about this opportunity.’ Detected emotion: joy with intensity 0.9. (1) Summarize the answer. (2) Evaluate how consistent the emotion is with the content. (3) Provide a reliability score from 0 to 100 and a short justification.”

Server outputs the emotion-aware reliability prompt sentence to the generative AI model.

### Step 17

Server computes reliability information and updates aptitude information.

Server receives, as input, the emotion-aware reliability prompt sentence and sends it to the generative AI model.

Server receives text containing a reliability score and justification, parses the score value, and converts it to a numeric reliability information value. Server then applies predefined rules to adjust aptitude information, for example by increasing or decreasing motivation-related scores based on the reliability value.

Server outputs updated reliability information and aptitude information and stores them in the evaluation record.

### Step 18

Server aggregates evaluation values across multiple items.

Server receives, as input, evaluation value information and reliability information for a plurality of evaluation items collected across multiple questions.

Server applies weighting coefficients and aggregation functions (such as weighted averaging) to compute comprehensive evaluation value information. Server also assembles explanation sentence information by concatenating or generating summaries of item-level explanations via another prompt sentence if needed.

Server outputs a comprehensive evaluation record including overall scores, item-level scores, reliability measures, aptitude measures, and associated explanations.

### Step 19

Terminal retrieves and displays evaluation results.

Terminal receives, as input, a response from the server containing the comprehensive evaluation record and related textual explanations.

Terminal formats the data into visual elements such as score bars, tables, and short explanation texts, and displays them on the screen. Terminal may highlight items where scores or reliability values fall below configured thresholds.

Terminal outputs an evaluation result view to the user for review.

### Step 20

User reviews evaluation information and optionally provides feedback or decisions.

User receives, as input, the displayed evaluation results including overall and item-level scores and explanations.

User inspects the information and may select controls on the terminal to indicate decisions such as “proceed,” “hold,” or “reject,” or to request a follow-up session.

User outputs decision information or feedback to the terminal, which forwards it to the server for logging and possible further processing.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

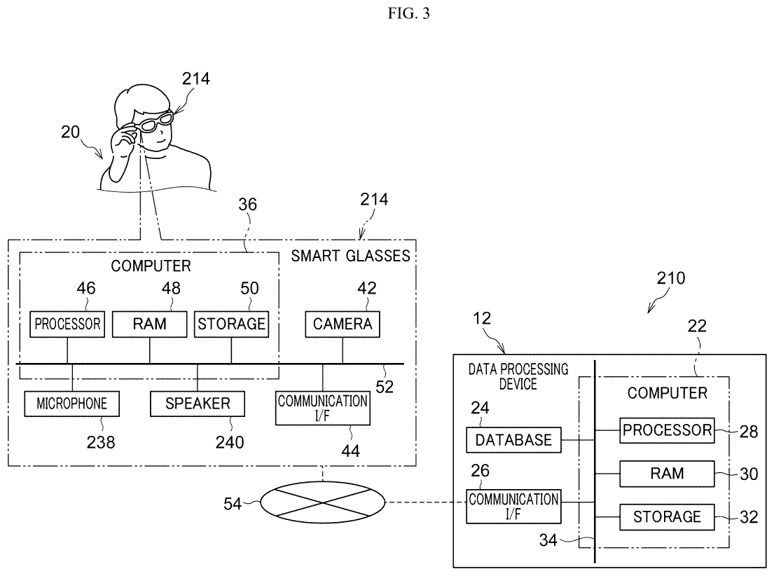

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

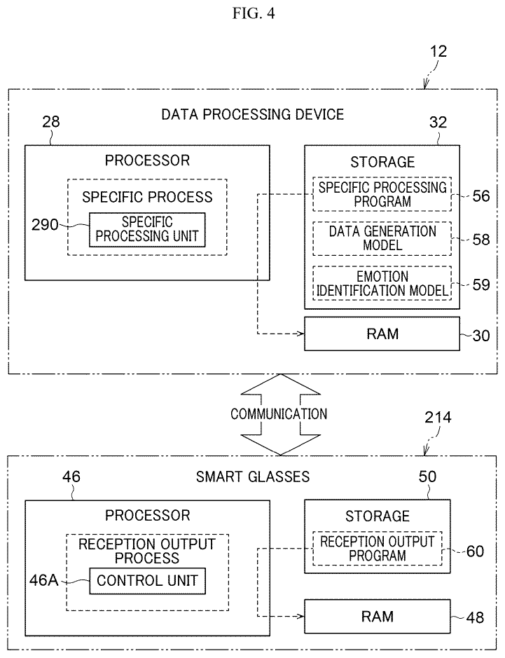

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

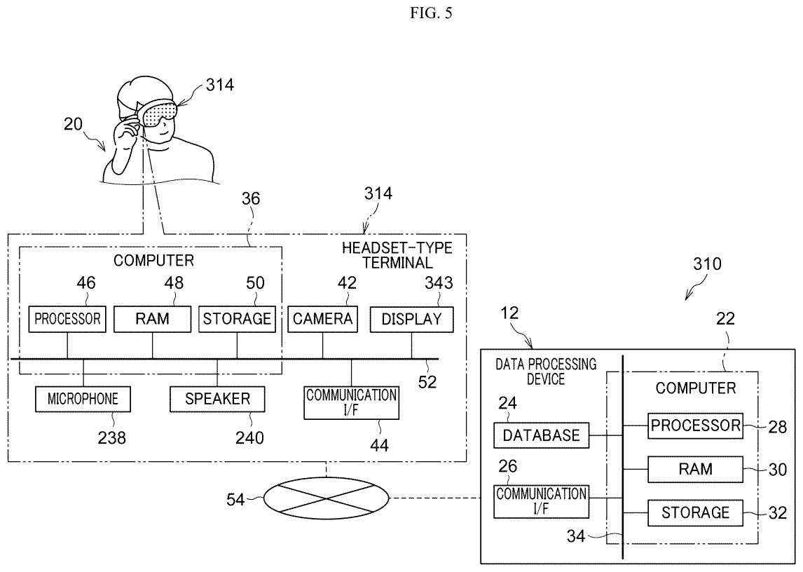

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

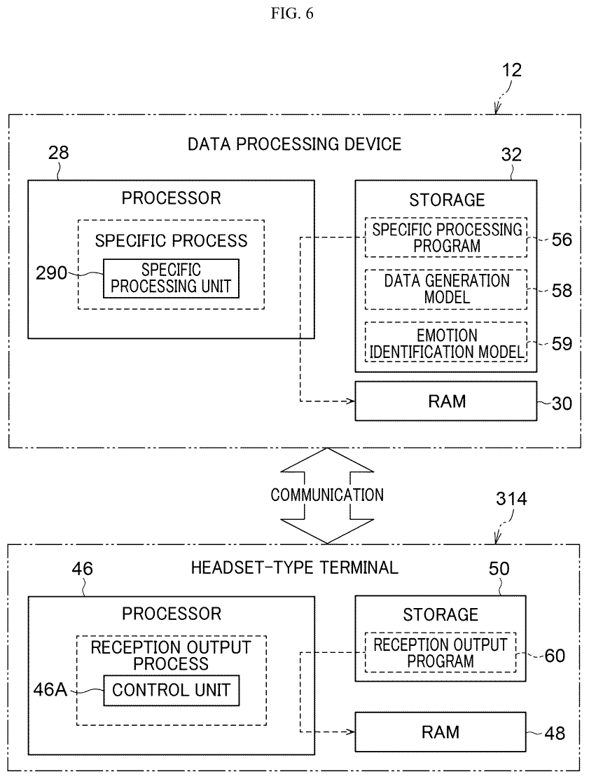

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

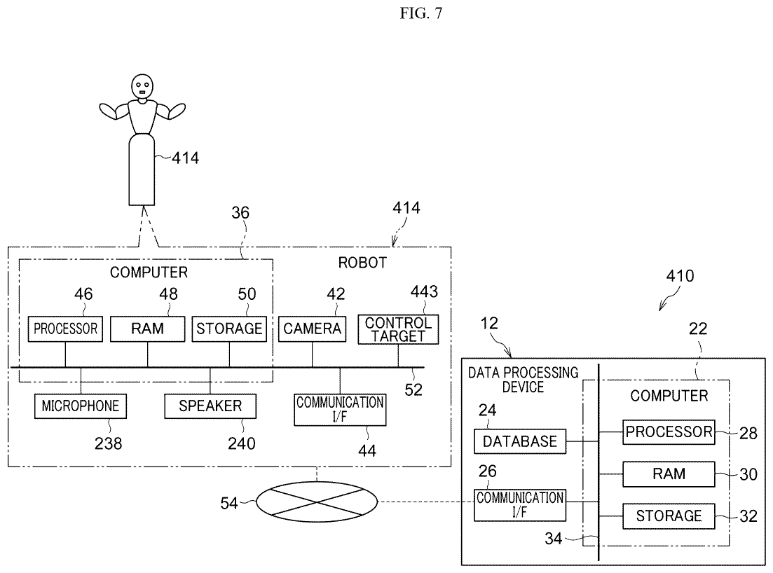

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

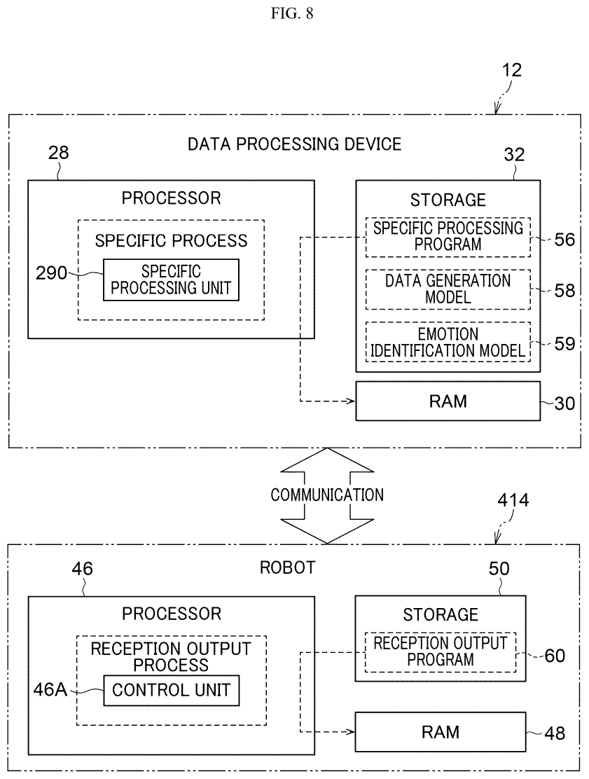

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

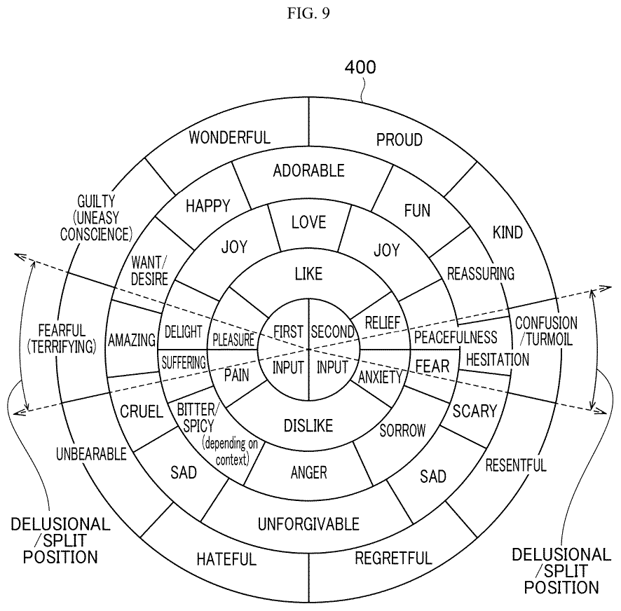

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

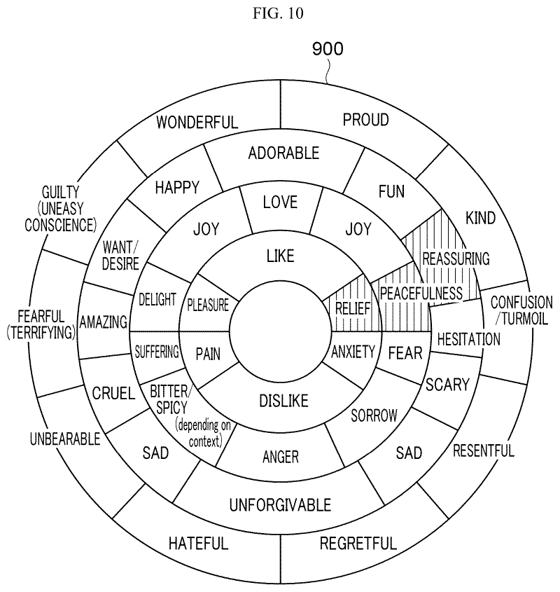

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor, a storage device configured to store structured information, a communication interface, an audio processing device, and an image processing device,
wherein the processor is configured to
acquire, from the storage device, an interview question group based on identification information, and hold the interview question group in a working memory area,
receive, via the communication interface, authentication information and interview type information from a terminal, generate an interview session identifier, transmit the interview session identifier to the terminal, and manage interview state information based on the interview session identifier,
generate a prompt sentence for a generative AI model using at least a part of the interview question group as input information, transmit the prompt sentence to the generative AI model,
acquire an initial question sentence for presentation to an applicant from the generative AI model, and transmit the initial question sentence to the terminal,
receive, from the terminal via the communication interface, response information including the interview session identifier and an answer text of the applicant, and store the response information in association with the interview session identifier in the storage device,
generate an analysis prompt sentence including the answer text, transmit the analysis prompt sentence to the generative AI model, acquire analysis result information including key point information relating to a motivation and an ability of the applicant and point-to-probe information indicating items to be further explored, and store the analysis result information in the storage device,
generate a follow-up question generation prompt sentence using the analysis result information as input information, transmit the follow-up question generation prompt sentence to the generative AI model, acquire an additional question sentence for the applicant from the generative AI model, and transmit the additional question sentence to the terminal,
determine, based on question history information and answer history information corresponding to the interview session identifier, whether to continue execution of an interview or to terminate the interview, and, when it is determined to terminate the interview, generate an evaluation prompt sentence that summarizes the question history information, the answer history information, and the analysis result information, transmit the evaluation prompt sentence to the generative AI model, acquire summary information of the applicant and suitability evaluation information from the generative AI model, and record the suitability evaluation information as score information in the storage device, and
estimate emotional state information of the applicant based on audio information obtained from the audio processing device and image information obtained from the image processing device, and reflect the emotional state information in the suitability evaluation information.

### Supplementary 2

The system according to supplementary 1,
wherein the processor is configured to change content of the follow-up question generation prompt sentence in accordance with the point-to-probe information included in the analysis result information and to automatically generate different additional question sentences for respective applicants.

### Supplementary 3

The system according to supplementary 1,
wherein the processor is configured to calculate a reliability index based on the emotional state information with respect to the suitability evaluation information, and to record the reliability index in association with the score information in the storage device.

### Application Example 1

### Supplementary 1

A system comprising a processor,
wherein the processor is configured to
generate a prompt sentence to be input to a generative AI model and generate an inquiry regarding applicant motivation information and capability information, and
acquire audio information via a terminal device, convert the audio information into character information by speech recognition processing, and obtain a text-form answer of an applicant as answer information, and
apply natural language processing to the answer information to extract syntactic information and semantic information and generate structured data including motivation information, experience information, and capability information of the applicant, and
automatically generate a prompt sentence for the generative AI model based on the structured data and interview context information, obtain a follow-up interview question sentence from the generative AI model, and determine the follow-up interview question sentence as a subsequent question, and
generate summary information from a plurality of questions presented to the applicant and answers obtained from the applicant, calculate a degree of conformity with a stored target personnel profile based on the summary information and the structured data, and generate numerical evaluation information as a score, and
execute audio analysis processing and image analysis processing on audio information and image information of the applicant, estimate emotional state information, and generate reliability evaluation information by reflecting the emotional state information in the numerical evaluation information, and
output the numerical evaluation information and the reliability evaluation information to a management display device for use in hiring decision by an interviewer.

### Supplementary 2

The system according to supplementary 1,
wherein the processor is configured to
determine missing information or ambiguous information included in the structured data obtained by the natural language processing, generate a prompt sentence to be input to the generative AI model based on a result of the determination, obtain an additional question sentence from the generative AI model, and sequentially output the additional question sentence to the terminal device.

### Supplementary 3

The system according to supplementary 1,
wherein the processor is configured to
calculate the numerical evaluation information based on the degree of conformity with the target personnel profile, evaluate temporal change and consistency of the emotional state information,
correct reliability of the numerical evaluation information according to a result of the evaluation, and present a corrected evaluation result to the management display device.

### Example 2

### Supplementary 1

A system comprising a processor, a storage device coupled to the processor, and an input/output device coupled to the processor and configured to access information in the storage device,
wherein the processor is configured to
acquire response information of an evaluation target person as text information from a terminal via the input/output device and store the text information in an information management area of the storage device,
generate a prompt sentence including the response information stored in the storage device so as to create a prompt sentence that instructs generation of a summary of the response information or generation of additional question information based on the response information,
transmit the prompt sentence to an external or internal generative AI model and obtain, from the generative AI model, a generation result including summary information of the response information or the additional question information,
store the summary information included in the generation result in an evaluation information management area of the storage device and calculate a quantitative index indicating suitability of the evaluation target person by comparing the summary information with evaluation criterion information stored in the storage device,
output the quantitative index and the additional question information included in the generation result to the terminal via the input/output device so that an evaluator can mutually compare the summary information and the quantitative index of a plurality of evaluation target persons, and
store the quantitative index in association with the response information and the summary information stored in the storage device and manage the quantitative index as evaluation history information usable for subsequent evaluation processing or model update processing.

### Supplementary 2

The system according to supplementary 1,
wherein the processor is configured to analyze the response information stored in the storage device, generate a prompt sentence including an analysis result of the response information, and
input the prompt sentence to the generative AI model so that the generative AI model generates additional question information for further exploring content of the response information.

### Supplementary 3

The system according to supplementary 1,
wherein the processor is configured to perform determination processing on the summary information obtained from the generative AI model based on the evaluation criterion information, calculate classification information and reliability information in addition to the quantitative index, store the classification information and the reliability information in the storage device, and output the classification information and the reliability information to the terminal.

### Application Example 2

### Supplementary 1

A system comprising a processor,
wherein the processor is configured to
generate, by using a generative information processing model, a prompt sentence for questioning, and present, via a terminal device, a first question regarding motivation information and capability information of a subject,
acquire audio information and character information of the subject from the terminal device, input the audio information to a recognition processing device, convert the audio information into character information, and store the character information as answer information, input the answer information to the generative information processing model together with a question-generation prompt sentence, automatically generate at least one follow-up question in accordance with a content of the answer information, and present the at least one follow-up question via the terminal device,
execute natural language processing on the answer information, extract key point information to generate summary information, compare the answer information with reference person information or reference condition information to calculate consistency information, and
numericalize evaluation value information based on the consistency information,
input audio information and image information of the subject to an emotion estimation processing device, estimate emotion state information based on acoustic feature information and visual feature information, and integrate the emotion state information into the evaluation value information to calculate reliability information and aptitude information,
record the evaluation value information, the reliability information, and the aptitude information as interview evaluation information, and output the interview evaluation information to the terminal device,
dynamically construct, based on template information, a prompt sentence to be given to the generative information processing model from input data including the reference person information or the reference condition information and the emotion state information, and
manage a plurality of types of prompt sentences respectively corresponding to question generation, summary generation, consistency calculation, reliability calculation, and aptitude calculation, and
determine selection result information or recommended action information for the subject based on the evaluation value information and the reliability information, and provide the selection result information or the recommended action information to a display device or an external information processing device.

### Supplementary 2

The system according to supplementary 1,
wherein the processor is configured to generate the prompt sentence to be given to the generative information processing model as at least one of a question-generation prompt sentence, a summary-generation prompt sentence, a consistency-evaluation prompt sentence, an emotion-consistency-evaluation prompt sentence, and an overall-evaluation prompt sentence from the template information, and to insert the answer information, the reference person information or the reference condition information, and the emotion state information as embedded variables into the prompt sentence so as to obtain, from the generative information processing model, different output formats for respective tasks.

### Supplementary 3

The system according to supplementary 1,
wherein the processor is configured to calculate comprehensive evaluation value information by weighting the evaluation value information and the reliability information for a plurality of evaluation items, and to output explanation sentence information generated by the generative information processing model in association with the comprehensive evaluation value information, and record an evaluation process for each subject in a traceable manner.

What is claimed is:

1. A system comprising:
circuitry configured to:
acquire, from a storage device, an evaluation inquiry group based on identification information, and generate a first prompt sentence for a generative neural network model using at least a part of the evaluation inquiry group as input information, and obtain from the generative neural network model an initial inquiry sentence;
transmit, via a communication interface coupled to a packet-switched network, the initial inquiry sentence as a notification data packet to a terminal device, and receive response information comprising an answer text from the terminal device;
generate an analysis prompt sentence including the answer text, input the analysis prompt sentence to the generative neural network model, and acquire analysis result information comprising key point information and point-to-probe information indicating items to be further explored;
generate a follow-up inquiry generation prompt sentence using the analysis result information, input the follow-up inquiry generation prompt sentence to the generative neural network model, and acquire an additional inquiry sentence for transmission to the terminal device;
determine, based on inquiry history information and answer history information, whether to continue or terminate an evaluation session, and when termination is determined, generate an evaluation prompt sentence summarizing the inquiry history information, the answer history information, and the analysis result information, input the evaluation prompt sentence to the generative neural network model, and acquire summary information and conformity evaluation information comprising a conformity index with reference criterion information; and
estimate emotional state information of a subject based on audio information obtained from an audio processing device and image information obtained from an image processing device, and calculate a reliability index based on the emotional state information with respect to the conformity evaluation information.

2. The system according to claim 1, wherein the circuitry is configured to receive authentication information and session type information from the terminal device via the communication interface, generate a session identifier, and manage evaluation state information based on the session identifier.

3. The system according to claim 1, wherein the circuitry is configured to receive audio data from the terminal device, apply speech recognition processing comprising an acoustic model and a language model to convert the audio data into character string data, and use the character string data as the answer text.

4. The system according to claim 3, wherein the circuitry is configured to apply natural language processing to the answer text comprising tokenization, syntactic analysis, and semantic analysis to extract structured data including intent information, experience information, and capability information of the subject.

5. The system according to claim 4, wherein the circuitry is configured to determine missing information or ambiguous information in the structured data, generate a prompt sentence based on the determination result, and obtain from the generative neural network model an additional inquiry sentence addressing the missing or ambiguous information.

6. The system according to claim 1, wherein the circuitry is configured to change content of the follow-up inquiry generation prompt sentence in accordance with the point-to-probe information to automatically generate different additional inquiry sentences for respective subjects.

7. The system according to claim 1, wherein the generative neural network model comprises a transformer-based architecture including multiple self-attention layers and feed-forward layers, and wherein the circuitry is configured to dynamically construct prompt sentences from input data including the reference criterion information and the emotional state information based on template information.

8. The system according to claim 7, wherein the circuitry is configured to manage a plurality of types of prompt sentences respectively corresponding to inquiry generation, summary generation, conformity calculation, reliability calculation, and aptitude calculation.

9. The system according to claim 1, wherein the conformity index is calculated by comparing the summary information and the structured data extracted from the answer history information with the reference criterion information stored in the storage device, and converting a degree of conformity into a numerical score.

10. The system according to claim 9, wherein the circuitry is configured to evaluate temporal change and consistency of the emotional state information throughout the evaluation session, and to correct reliability of the conformity index based on the temporal change and consistency evaluation.

11. The system according to claim 1, wherein the emotional state information is estimated based on acoustic feature information extracted from the audio information comprising at least one of a fundamental frequency, an energy distribution, or a speech rate, and visual feature information extracted from the image information comprising at least one of a facial landmark position, an expression classification, or a gaze direction.

12. The system according to claim 1, wherein the circuitry is configured to record the conformity evaluation information, the reliability index, and the summary information as evaluation record data in the storage device in association with a subject identifier.

13. The system according to claim 12, wherein the circuitry is configured to output the evaluation record data to a management display device via the communication interface for review by an evaluator.

14. The system according to claim 1, wherein the circuitry is configured to store the answer history information and the analysis result information in the storage device and to use the stored information for subsequent model update processing or evaluation criterion refinement.

15. The system according to claim 1, wherein the circuitry is configured to perform determination processing on the summary information based on the reference criterion information to calculate classification information and reliability information in addition to the conformity index, and to store the classification information and the reliability information in the storage device.

16. The system according to claim 1, wherein the circuitry is configured to generate summary information from a plurality of inquiry sentences presented and answers obtained, and to enable an evaluator to compare summary information and conformity indices across a plurality of subjects via the terminal device.

17. The system according to claim 1, wherein the circuitry is configured to receive image information of the subject from a camera device of the terminal device, apply facial expression analysis processing to the image information to detect expression classification data, and integrate the expression classification data with the acoustic feature information to produce the emotional state information.

18. A system comprising:
circuitry configured to:
acquire, from a storage device, an evaluation inquiry group, generate a first prompt sentence for a generative neural network model comprising a transformer-based architecture, and obtain an initial inquiry sentence from the generative neural network model;
transmit, via a communication interface coupled to a packet-switched network, the initial inquiry sentence to a terminal device, receive response information comprising audio data and an answer text, and apply speech recognition processing to the audio data to generate character string data;
apply natural language processing including syntactic analysis and semantic analysis to the answer text to extract structured data, generate an analysis prompt sentence, input the analysis prompt sentence to the generative neural network model, and acquire key point information and point-to-probe information;
generate follow-up inquiry prompt sentences based on the point-to-probe information, obtain additional inquiry sentences from the generative neural network model, and iteratively transmit the additional inquiry sentences to the terminal device and receive subsequent response information;
generate an evaluation prompt sentence summarizing inquiry history information and answer history information, input the evaluation prompt sentence to the generative neural network model, acquire summary information and a conformity index with reference criterion information, estimate emotional state information based on acoustic feature information and visual feature information extracted from audio data and image data of a subject, and calculate a reliability index based on the emotional state information; and
transmit, via the communication interface, a notification data packet comprising the conformity index, the reliability index, and the summary information to a management display device.

19. The system according to claim 18, wherein the circuitry is configured to manage a plurality of types of prompt sentences corresponding to inquiry generation, summary generation, conformity calculation, and reliability calculation, and to dynamically construct each prompt sentence from template information, the reference criterion information, and the emotional state information.

20. A method comprising:
acquiring, from a storage device, an evaluation inquiry group based on identification information, and generating a first prompt sentence for a generative neural network model using at least a part of the evaluation inquiry group as input information, and obtaining from the generative neural network model an initial inquiry sentence;
transmitting, via a communication interface coupled to a packet-switched network, the initial inquiry sentence as a notification data packet to a terminal device, and receiving response information comprising an answer text from the terminal device;
generating an analysis prompt sentence including the answer text, inputting the analysis prompt sentence to the generative neural network model, and acquiring analysis result information comprising key point information and point-to-probe information indicating items to be further explored;
generating a follow-up inquiry generation prompt sentence using the analysis result information, inputting the follow-up inquiry generation prompt sentence to the generative neural network model, and acquiring an additional inquiry sentence for transmission to the terminal device;
determining, based on inquiry history information and answer history information, whether to continue or terminate an evaluation session, and when termination is determined, generating an evaluation prompt sentence summarizing the inquiry history information, the answer history information, and the analysis result information, inputting the evaluation prompt sentence to the generative neural network model, and acquiring summary information and conformity evaluation information comprising a conformity index with reference criterion information; and
estimating emotional state information of a subject based on audio information obtained from an audio processing device and image information obtained from an image processing device, and calculating a reliability index based on the emotional state information with respect to the conformity evaluation information.
